(19) United States
(12) Patent Application Publication
(10) Pub. No.: US 2021/0272138 A1
(43) Pub. Date: Sep. 2, 2021

(54) METHOD AND APPARATUS FOR DATA PROCESSING

(71) Applicant: ALIBABA GROUP HOLDING LIMITED, George Town (KY)

(72) Inventors: Yi MENG, Beijing (CN); Yating CAO, Hangzhou (CN); Shibo LIU, Hangzhou (CN)

(21) Appl. No.: 17/188,660

(22) Filed: Mar. 1, 2021

(30) Foreign Application Priority Data
Feb. 28, 2020 (CN) 202010131639.9

(51) Int. Cl. G06Q 30/02

(52) U.S. Cl. CPC G06Q 30/0201; G06Q 30/0205

(57) ABSTRACT

Embodiments of the present disclosure provide data processing methods and devices. The method comprises determining first feature information of one or more second users corresponding to a first user and second feature information of one or more to-be-selected commodity objects; determining one or more first matching degrees in at least one first feature dimension between the one or more second users and the one or more to-be-selected commodity objects according to the first feature information and the second feature information; and determining target commodity object information corresponding to the first user according to the one or more first matching degrees.

### CROSS-REFERENCE TO RELATED APPLICATION

The present disclosure claims the benefits of priority to Chinese Patent Application No. 202010131639.9 filed on Feb. 28, 2020, which is incorporated herein by reference in its entirety.

### BACKGROUND

With the continuous development of technologies in the fields of e-commerce and mobile Internet, shopping live broadcast platforms have been increasingly widely used. Taking Taobao live broadcast as an example, users can purchase commodities being sold by a host while watching a live broadcast for promoting commodities such as infant products and makeup products.

A merchant provides commodity objects for live broadcasting in a commodity pool of a live broadcast content platform. The host can see the commodities issued by the merchant in a commodity selection pool and select some commodities for promoting in a live broadcast event. According to the sales of the commodities, the host may obtain certain commission income from the merchant. How well the host selects commodities or how well the commodities that the host selects meet demands of fans of the host may directly affect the live broadcast income. In some conventional systems, a live broadcast platform provides an interface to a host for commodity selection. The host searches for some commodities using criterion determined based on the host's personal experiences and manually determines the commodities for the live broadcast events among the found commodities.

Without any data mining support, it is difficult for the host in a small and medium-sized business not equipped with strong data analysis capability to have an accurate analysis on purchasing behaviors and preferences of the fans who watch the live broadcast events (such as categories and price ranges of commodities preferred by the fans). Therefore, it is difficult for the host to have an accurate judgment on a matching degree between the fans and commodities. Moreover, the quality of to-be-selected commodities and the reputation and service quality of corresponding merchants of the commodities are also not clear enough for the host's judgement. In this regard, the commodities that do not meet the needs of fans and the merchants with poor product quality and poor reputation may end up being selected. The host's fans may be dissatisfied with the commodities and discouraged for future participation and purchase.

### SUMMARY

Embodiments of the present disclosure provide data processing methods and devices. The method comprises determining first feature information of one or more second users corresponding to a first user and second feature information of one or more to-be-selected commodity objects; determining one or more first matching degrees in at least one first feature dimension between the one or more second users and the one or more to-be-selected commodity objects according to the first feature information and the second feature information; and determining target commodity object information corresponding to the first user according to the one or more first matching degrees.

### BRIEF DESCRIPTION OF THE DRAWINGS

The accompanying drawings described herein are used to provide further understanding of the present disclosure and constitute a part of the present disclosure. Exemplary embodiments of the present disclosure and descriptions of the exemplary embodiments are used to explain the present disclosure and are not intended to constitute inappropriate limitations to the present disclosure. In the accompanying drawings:

FIG. 1 is a schematic diagram of an exemplary data processing system, consistent with some embodiments of the present disclosure.

FIG. 2 is a schematic diagram of an exemplary data processing system, consistent with some embodiments of the present disclosure.

FIG. 3 is a schematic diagram of an exemplary data processing process, consistent with some embodiments of the present disclosure.

FIG. 4 is a schematic diagram of an exemplary data processing system, consistent with some embodiments of the present disclosure.

FIG. 5 is a schematic diagram of an exemplary data processing system, consistent with some embodiments of the present disclosure.

FIG. 6 is a schematic diagram of an exemplary data processing process, consistent with some embodiments of the present disclosure.

FIG. 7 is a schematic diagram of an exemplary data processing system, consistent with some embodiments of the present disclosure.

FIG. 8 is a schematic diagram of an exemplary data processing process, consistent with some embodiments of the present disclosure.

### DETAILED DESCRIPTION

To facilitate understanding of the solutions in the present disclosure, the technical solutions in some of the embodiments of the present disclosure will be described with reference to the accompanying drawings. It is appreciated that the described embodiments are merely a part of rather than all the embodiments of the present disclosure. Consistent with the present disclosure, other embodiments may be obtained without departing from the principles disclosed herein. Such embodiments shall also fall within the protection scope of the present disclosure.

As described above, manual selection of commodities by a host of a live sales broadcast does not address consumer audience's needs well. The embodiments of the present disclosure provide technical solutions to address the above problems. An exemplary system may provide data processing methods for commodity selection and host selection for the live sales broadcasts based on matching relationships in various attributes between the commodities, the consumer audience, the hosts, and the merchants that provide the commodities.

The exemplary system determines, through a server, first feature information of at least one second user corresponding to a first user and second feature information of to-be-selected commodity objects; determines first matching degrees in at least one first feature dimension between a second user group and the to-be-selected commodity objects according to the first feature information and the second feature information; determines target commodity object information corresponding to the first user at least according to the first matching degrees; and receives and displays, through a client terminal, the target commodity object information sent by the server terminal for manual commodity selection by the first user. In the exemplary system, association relationships between the fans and the commodities are determined based on a portrait of a host's fan group and commodity portraits, and matching degrees between the fans and the commodities are considered to select commodities suitable for the fan group. Therefore, the quality and efficiency of commodity selection can be improved, thereby enhancing the live broadcast income.

The exemplary system also determines, through a server, first feature information of at least one second user corresponding to first users and second feature information of a commodity object for sale of a third user; determines first matching degrees in at least one first feature dimension between a second user group and the commodity object for sale according to the first feature information and the second feature information; determines target first user information corresponding to the third user at least according to the first matching degrees; and receives, through a client terminal, the target first user information sent by the server terminal, and displays the target first user information for manual host selection by the third user. In the exemplary system, association relationships between fans and a commodity sold by a merchant can be determined based on portraits of the host's fan groups and a portrait of the commodity, and matching degrees between the fans and the commodity are considered to select a host whose fan group is suitable for the commodity sold by the merchant. Therefore, the host selection quality and efficiency can be effectively improved, thereby increasing the income of commodity sales.

The exemplary system also determines, through a server, multiple pieces of first user information in a target place; determines first feature information of at least one second user corresponding to the first users and second feature information of a commodity object for sale of a third user in the target place; determines first matching degrees in at least one first feature dimension between a second user group and the commodity object for sale according to the first feature information and the second feature information; determines target first user information corresponding to the third user at least according to the first matching degrees; and receives, through a client terminal, the target first user information sent by the server terminal, and displays the target first user information for the third user to manually determine a host who sells the commodity object in a live broadcast manner. In the exemplary system, for first users at a site of a third user, association relationships between fans and a commodity sold by a merchant may be determined based on portraits of the first users' fan groups and a portrait of the commodity, and matching degrees between the fans and the commodity are considered to select a first user as a host whose fan group is suitable for the commodity sold by the merchant. Therefore, the host selection quality and efficiency can be effectively improved, thereby increasing the income of commodity sales.

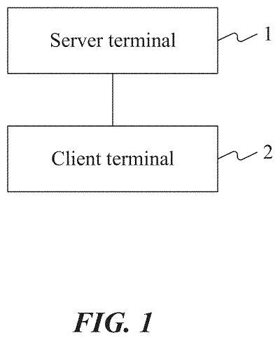

FIG. 1 is a schematic diagram of an exemplary data processing system, consistent with some embodiments of the present disclosure, the system comprises: server terminal 1 and client terminal 2.

Server terminal 1 may be a server terminal deployed on a cloud server, or a server dedicated for realizing live broadcast commodity selection management and may be deployed in a data center. The server may be a cluster server or a single server.

Client terminal 2 comprises, but is not limited to, a mobile communication device, that is, a mobile phone or a smart phone in general, and also comprises a terminal device such as a personal computer, a PAD, and an iPad.

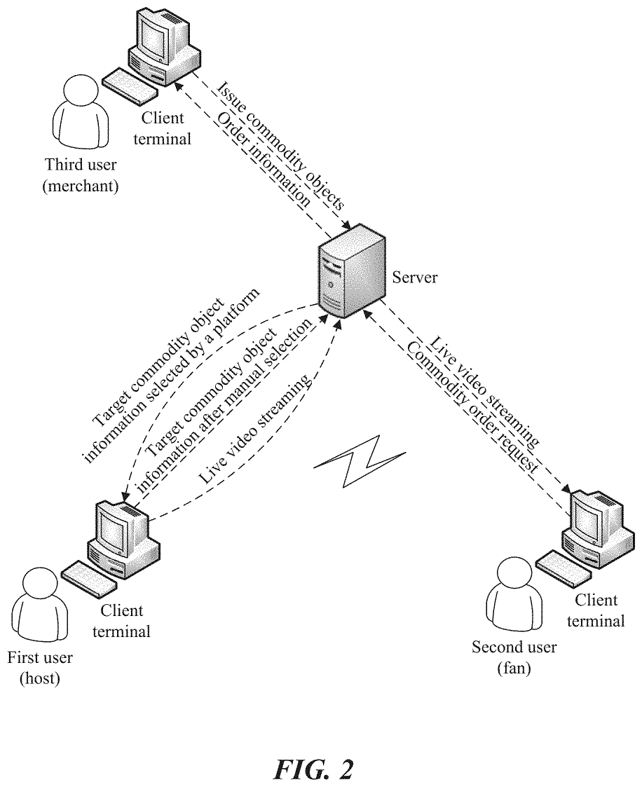

FIG. 2 is a schematic diagram of an exemplary data processing system, consistent with some embodiments of the present disclosure.

A third user (e.g., a merchant) issues commodity objects to be promoted by a first user (e.g., a host) to a commodity object pool of the system as to-be-selected commodity objects. Server terminal 1 determines, at least based on a portrait of a second user group (e.g., a fan user group of fans) corresponding to the first user and portraits of the to-be-selected commodity objects, association relationships between the second user group and entities in a host commodity selection scenario such as the to-be-selected commodity objects, and in consideration of matching degrees between the user group and the commodities, selects, for the host, target commodity objects suitable for the fan group of the host. Client terminal 2 displays the target commodity object information selected by the system, and the first user manually selects a commodity according to this information. The first user conducts live sales of selected commodity objects on a live broadcast platform through his/her client terminal. At the same time, second users watch the live program through their client terminals and can purchase the commodities being sold by the host while watching the commodity sales live program. Server terminal 1 may receive commodity order requests of the second users, generate order information, and send it to a client terminal of the third user. The third user performs order fulfillment processing according to the order information.

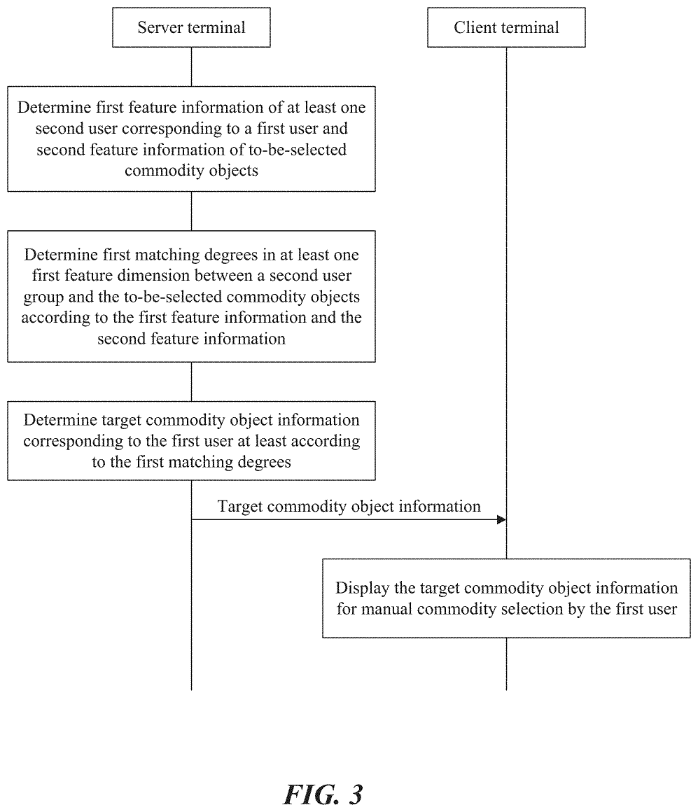

FIG. 3 is a schematic diagram of an exemplary data processing process, consistent with some embodiments of the present disclosure.

A server determines first feature information of at least one second user corresponding to a first user and second feature information of to-be-selected commodity objects. The server also determines first matching degrees in at least one first feature dimension between a second user group and the to-be-selected commodity objects according to the first feature information and the second feature information. After determining the first matching degrees, the server determines target commodity object information corresponding to the first user at least according to the first matching degrees. The server provides the target commodity object information to the client terminal, which displays the target commodity object information for manual commodity selection by the first user.

The first user may be a host user. A host user usually has multiple fan users, such as users who follow the host user. In some embodiments, a fan user is referred to as a second user, or referred to as a buyer user. Multiple fan users corresponding to one host user form a fan user group of the host user. The fan user group is referred to as the second user group. Table 1 shows the correspondence between first users and second users.

TABLE 1
Correspondence between first users and second users

| First user identifier | Second user identifier |
|---|---|
| Host user 1 | Fan user 1 |
| Host user 1 | Fan user 2 |
| . . . | . . . |
| Host user 1 | Fan user n |
| Host user 2 | Fan user n + 1 |
| . . . | . . . |

It should be noted that one second user may correspond to different first users. In other words, the second user groups corresponding to different first users may have partially overlapping second users.

The first feature information comprises feature information of a second user, which is also referred to as portrait information of the second user. The first feature information may comprise user portrait information in multiple first feature dimensions, including but not limited to: commodity category preference information, commodity price preference information for different commodity categories, commodity function preference information for different commodity categories, and so on.

The commodity category preference information may be determined in the following manner: the commodity category preference information is determined according to historical interaction behavior information of the second user. The historical interaction behavior information comprises but is not limited to: historical purchase behavior information of the second user on a commodity object, historical browsing behavior information of the second user on the commodity object, historical favoriting behavior information of the second user on the commodity object, and evaluation information of the second user on historically purchased commodity objects.

In some embodiments, the historical interaction behavior information is usually stored in a log file of an e-commerce platform. The server may extract the historical interaction behavior information from the log file according to the second user identifier, and determine the commodity category preference information through a certain algorithm. For example, commodity category preference information of second user A comprises: a skirt sub-category under a clothing category, a grapefruit sub-category under a fresh produce category, and a pants sub-category under a children's clothing category; commodity category preference information of second user B comprises: a mobile phone sub-category under a small household appliances category, a sports shoes sub-category under a shoes and hats category, and so on.

The commodity price preference information may be determined in the following manner: determining the commodity price preference information according to the historical interaction behavior information of the second user. For example, for second user A, the skirt purchased is usually between 300 and 500 yuan, the grapefruit purchased is usually 5 to 10 yuan/jin, and the children's pants purchased are usually between 150 and 300 yuan. For second user B, the mobile phone purchased is usually between 3000 and 5000 yuan, and the sports shoes purchased are usually between 500 and 1000 yuan.

The commodity function preference information may be determined in the following manner: determining the commodity function preference information according to the historical interaction behavior information of the second users. For example, the commodity function preference information is extracted from evaluation information of the second user on the purchased commodity objects. If the evaluation of second user A for the purchased grapefruit is: “small and sour,” function preference information of the user for grapefruit is: big and sweet. If the evaluation of second user B for the purchased sports shoes is: “the sole is a bit hard,” function preference information of the user for sports shoes is: the sole is soft and has an air cushion. If the evaluation of second user B for the purchased mobile phone is: “it doesn't look good,” function preference information of the user for mobile phone is: the appearance is fashionable. The function preference information indicates what a user prefers. Such preference is determined based on what the user likes or does not like about the commodities.

The second feature information comprises feature information of the to-be-selected commodity object, which is also referred to as commodity portrait information. The to-be-selected commodity object may be a commodity object of any category, such as clothing, shoes and hats, and food, or a durable commodity such as a mobile phone and a kettle. The second feature information may be static attribute (basic attribute) information of the commodity object, such as price, function, and category. The static attribute of the commodity object may be obtained from a commodity database by searching. The second feature information may also be dynamic attribute information of the commodity object, such as a transaction volume, an order volume, a return order volume, etc. in the last 30 days. The dynamic attribute information of the commodity object may be extracted from the user interaction behavior information (which can be stored in a log file). The second feature information may comprise commodity portrait information in multiple second feature dimensions, including but not limited to: commodity category information, commodity price information, commodity function information, and so on.

After determining the first feature information of at least one second user corresponding to the first user and the second feature information of the to-be-selected commodity objects, the server determines first matching degrees in at least one first feature dimension between the second user group and the to-be-selected commodity objects according to the first feature information and the second feature information.

The second user group and the to-be-selected commodity objects may have first matching degrees in multiple first feature dimensions. The first feature dimension comprises but is not limited to: commodity category dimension, commodity price dimension, commodity function dimension, and so on.

In some embodiments, the first feature information comprises: commodity category preference information; the second feature information comprises: commodity category information; the first feature dimension is a commodity category dimension; and the first matching degree in the commodity category dimension may be determined by the following steps: 1) for each second user, determining a third matching degree between the second user and a commodity category of a to-be-selected commodity according to the commodity category preference information of the second user; and 2) determining the first matching degree in the commodity category dimension according to the third matching degrees. As a static attribute of the to-be-selected commodity object, the commodity category can be obtained from the commodity database by searching.

In some embodiments, the determining the first matching degree in the commodity category dimension according to the third matching degrees may be performed in the following manner: using an average value of the third matching degrees as the first matching degree in the commodity category dimension, that is: calculating an average value of third matching degrees between all second users of the first user and the commodity category of the to-be-selected commodity object respectively, and using the average value of the third matching degrees of all the second users as the first matching degree in the commodity category dimension between the second user group and the commodity object. For example, a host user has 500 fan users, and third matching degrees between commodity category preference information of the fan users and a commodity category of commodity object A are: 0.5, 0.26, 0.78 . . . , then an average value of these third matching degrees is used as the first matching degree in the commodity category dimension between the 500 fan users and commodity object A.

In some embodiments, the determining the first matching degree in the commodity category dimension according to the third matching degrees may also be performed in the following manner: determining the quantity of second users whose third matching degrees are greater than a third matching degree threshold; and using a ratio of the quantity of the second users to the quantity of all second users as the first matching degree in the commodity category dimension. For example, the third matching degree threshold is 0.5, a host user has 500 fan users, among which 200 fan users have third matching degrees between the commodity category preference information and the commodity category of commodity object A greater than or equal to 0.5, and thus the first matching degree between the 500 fan users and commodity object A in the commodity category dimension is 200/500=0.4.

In some embodiments, the first feature information comprises commodity price preference information for different commodity categories; the second feature information comprises commodity price information; the first feature dimension is a commodity price dimension; and one first matching degree in the commodity price dimension may be determined in the following manner: determining the first matching degree in the commodity price dimension according to the commodity price preference information of the second users for a commodity category to which one commodity object belongs and the commodity price information of the commodity object.

In some embodiments, the determining the first matching degree in the commodity price dimension according to the commodity price preference information of the second users for a commodity category to which one commodity object belongs and the commodity price information of the commodity object may comprises the following sub-steps: 1) determining the quantity of second users whose commodity price preference information matches the commodity price information; and 2) using a ratio of the quantity of the second users to the quantity of all second users as the first matching degree in the commodity price dimension. For example, a host user has 500 fan users, and a commodity price of commodity object A falls within commodity price preference ranges of 200 fan users for the commodity category “skirt” of commodity object A, and thus the first matching degree between the 500 fan users and commodity object A in the commodity price dimension is 200/500=0.4.

In some embodiments, the first feature information comprises commodity function preference information for different commodity categories; the second feature information comprises commodity function information; the first feature dimension is a commodity function dimension; and one first matching degree in the commodity function dimension may be determined in the following manner: determining the first matching degree in the commodity function dimension according to the commodity function preference information of the second users for a commodity category to which one commodity object belongs and the commodity function information of the commodity object.

The commodity function preference information may be determined in the following manner: determining the commodity function preference information according to the historical interaction behavior information of the second users. For example, the commodity function preference information is extracted from evaluation information of the second user on the purchased commodity objects. If the evaluation of second user A for the purchased grapefruit is: small and sour, function preference information of the user for grapefruit is: big and sweet. If the evaluation of second user B for the purchased sports shoes is: the sole is a bit hard, function preference information of the user for sports shoes is: the sole is soft and has an air cushion. If the evaluation of second user B for the purchased mobile phone is: it doesn't look good, function preference information of the user for mobile phone is: the appearance is fashionable.

In some embodiments, the commodity function information of the commodity object may be determined in the following manners. In Manner 1, structured commodity function information is collected from the commodity object itself, such as efficacy parameters of each commodity object under a cosmetics category and style parameters of commodity objects in a clothing category, and major categories and detailed data structures may be sorted out to obtain corresponding fields, thus determining the commodity function information. In Manner 2, when the commodity function information cannot be obtained by Manner 1, it can be acquired from evaluation information of users on the commodity. For example, commodity function information of a purchased commodity object is extracted from evaluation information of a second user for the purchased commodity object. If the evaluation of second user A for the purchased grapefruit is: small and sour, function information of the grapefruit is: small in size and sour in taste. If the evaluation of second user B for the purchased sports shoes is: the sole is a bit hard, the function information of the sports shoes is: ordinary sole. If the evaluation of second user B for the purchased mobile phone is: it doesn't look good, function information of the mobile phone is: traditional style.

In some embodiments, the determining the first matching degree in the commodity function dimension according to the commodity function preference information of the second users for a commodity category to which one commodity object belongs and the commodity function information of the commodity object may comprise the following sub-steps: 1) determining the quantity of second users whose commodity function preference information matches the commodity function information; and 2) using a ratio of the quantity of the second users to the quantity of all second users as the first matching degree in the commodity function dimension. For example, a host user has 500 fan users, and a commodity function of commodity object A falls within commodity function preference ranges of 200 fan users for a commodity category “sports shoes” of commodity object A, and therefore, the first matching degree between the 500 fan users and commodity object A in the commodity function dimension is 200/500=0.4.

After determining the first matching degrees in at least one first feature dimension between the second user group and the to-be-selected commodity objects, server terminal 1 determines target commodity object information corresponding to the first user at least according to the first matching degrees.

In an example, server terminal 1 determines the target commodity object information corresponding to the first user according to the first matching degrees. In some embodiments, the first matching degrees in at least one first feature dimension can be weighted and summed according to a weight corresponding to each first feature dimension, and a weighted sum value can be used as a comprehensive matching degree of each to-be-selected commodity object. The to-be-selected commodity objects with top ranking comprehensive matching degrees are used as the target commodity object information. For example, to-be-selected commodity objects with the top 100 comprehensive matching degrees are selected as the target commodity object information.

In another example, server terminal 1 determines the target commodity object information corresponding to the first user according to the first matching degrees, the quality information of the to-be-selected commodity objects, and the quality information of the third user. In some embodiments, the first matching degrees in at least one first feature dimension, quality scores of one to-be-selected commodity object in at least one first quality dimension, and quality scores of the third user in at least one second quality dimension may be weighted and summed according to a weight corresponding to each first feature dimension, weights corresponding to various pieces of quality information of the to-be-selected commodity object, and weights corresponding to various pieces of quality information of the third user. A weighted sum value is used as a comprehensive score of the to-be-selected commodity object, and to-be-selected commodity objects having comprehensive scores ranked top are used as the target commodity object information. For example, to-be-selected commodity objects with the top 100 scores are selected as the target commodity object information.

The first quality dimension comprises but is not limited to: the number of positive evaluations for the commodity, which is determined based on evaluation information of the second users on the commodity object. The second quality dimension comprises but is not limited to: the number of user's positive evaluations of the third user, customer service quality score, logistics quality score, transaction dispute rate, and so on. The logistics service quality information comprises but is not limited to an average goods delivery time length. The customer service quality information comprises but is not limited to an average service response time length.

In another example, server terminal 1 is also configured to determine third feature information of the first user and fourth feature information of third users corresponding to the commodity objects; determine second matching degrees in at least one second feature dimension between the first user and the third users according to the third feature information and the fourth feature information; and specifically determine the target commodity object information at least according to the first matching degrees and the second matching degrees.

The third feature information comprises feature information of the first user, which is also referred to as portrait information of the first user. The third feature information comprises but is not limited to geographic location information, and may also comprise information such as merchant level preferences.

The fourth feature information comprises feature information of third users, which is also referred to as portrait information of the third users. A candidate commodity object belongs to a merchant user, and the merchant user is referred to as a third user. The fourth feature information comprises but is not limited to: geographic location information and may also comprise information such as merchant level.

In an example, the third feature information comprises: geographic location information of the first user; the fourth feature information comprises: geographic location information of the third users; the at least one second feature dimension comprises a distance dimension; and one second matching degree in the distance dimension is determined by the following step: determining the second matching degree in the distance dimension according to the geographic location information of the first user and the geographic location information of the third users. For example, if geographic locations of first user A and third user B are in the same city, and geographic locations of first user A and third user C are in different cities, the second matching degree in the distance dimension between first user A and third user B is higher.

In some embodiments, the server terminal may also be configured to determine the quality information of the commodity objects and the quality information of the third users; and is specifically configured to determine the target commodity object information according to the first matching degrees, the second matching degrees, the quality information of the commodity objects, and the quality information of the third users.

In some embodiments, the server terminal may be specifically configured to determine third matching degrees between the first user and the commodity objects according to the first matching degrees in the at least one first feature dimension, the second matching degrees in the at least one second feature dimension, the quality information of the commodity objects, and the quality information of the third users; and determine the target commodity object information according to the third matching degrees. For example, according to weights of commodity selection parameters, weighted values of the first matching degrees in the at least one first feature dimension, the second matching degrees in the at least one second feature dimension, the quality information of the commodity objects, and the quality information of the third users are used as the third matching degrees. Each of the first matching degrees, each of the second matching degrees, the quality information of one commodity object, and the quality information of one third user are all a commodity selection parameter, and each corresponds to a weight.

For example, a weight of a matching degree between the commodity category and the fan user is 0.1, a weight of a matching degree between the price range and the fan user is 0.5, a weight of the distance matching degree is 0.3, and so on. A finally obtained comprehensive matching degree of to-be-selected commodity object 1 is 98 points, a comprehensive matching degree of to-be-selected commodity object 2 is 50 points, and so on. Finally, the top 10 commodity objects are selected as target commodity objects under the commodity category.

The weight may be determined based on experiences, or may be determined by a machine learning algorithm. In an example, the weight is learned from a training data set. The training data may comprise: each first matching degree, each second matching degree, the quality information of the commodity objects, the quality information of the third users, and label information on whether the first user matches one commodity object.

The system determines association relationships between entities in a host commodity selection scenario, e.g., fans and commodities, the host and merchants, and so on based on portraits of the host's fan groups, commodity portraits, and merchant portraits, and in consideration of matching degrees between them, selects suitable commodities for the host and his/her fans. Therefore, the commodity selection quality and efficiency can be effectively improved, thereby increasing the live broadcast income.

In some embodiments, server terminal 1 is also configured to determine manual commodity selection parameter information of a target commodity object; and send the manual commodity selection parameter information to a client terminal of the first user for manual commodity selection by the first user according to the manual commodity selection parameter information.

The manual commodity selection parameter information is information according to which the first user performs secondary screening of the target commodity objects automatically determined by the system. The manual commodity selection parameter information comprises but is not limited to: the first matching degree in the at least one first feature dimension and the second matching degree in the at least one second feature dimension, and may also comprise the commodity sales forecast information, commodity object information, and third user information.

The commodity object information comprises but is not limited to: commodity static attribute information (such as commodity category information, commodity price information, and commodity function information), the number of positive evaluations for the commodity, and transaction statistical data. The transaction statistical data comprises but is not limited to: the quantity of commodity transactions within a target time range (such as the last 30 days), the quantity of orders, the amount of commodity transactions, and the quantity of return orders.

The third user information comprises but is not limited to: user basic attribute information (such as store opening time information, merchant user level information, fan user quantity information, and geographic location information), the number of user's positive evaluations, transaction statistical data, logistics service quality information, and customer service quality information.

The commodity sales forecast information comprises but is not limited to: commodity sales volume forecast information, commodity sales amount forecast information, and first user income forecast information.

Server terminal 1 may also be configured to determine at least one target second user according to the first matching degrees; determine the sales volume forecast information according to a historical purchase quantity of each target second user for commodity objects in a commodity category to which the commodity object belongs; determine the sales amount forecast information according to the sales volume forecast information; and determine the first user income forecast information according to the sales amount forecast information.

In some embodiments, for each target commodity object, the second users whose commodity category preference, commodity price preference, commodity function preference, and so on are consistent with the target commodity object can be determined. Then, according to a historical purchase quantity of each target second user for commodity objects in a commodity category to which the commodity object belongs, an average monthly purchase quantity of each second user for commodities in this category may be calculated, and a cumulative value of the purchase quantities of the second users is used as the sales volume forecast information. Next, the sales volume forecast value may be multiplied by the price of the commodity object, thereby determining the sales amount forecast information such as Gross Merchandise Value (GMV). Finally, the sales amount forecast information may be multiplied by a commission ratio to determine the commission the first user can gain. For example, a host user has 500 fan users, among which 200 fan users have commodity category preferences, commodity price preferences, commodity function preferences, and so on, consistent with target commodity object A. Fan user 1 buys about 10 pieces a month, fan 2 buys about 3 pieces a month, and so on. A predicted value of the total purchase quantity of the 200 fan users is multiplied by the price of target commodity object A to obtain the GMV, and the GMV is multiplied by the commission ratio to calculate the commission.

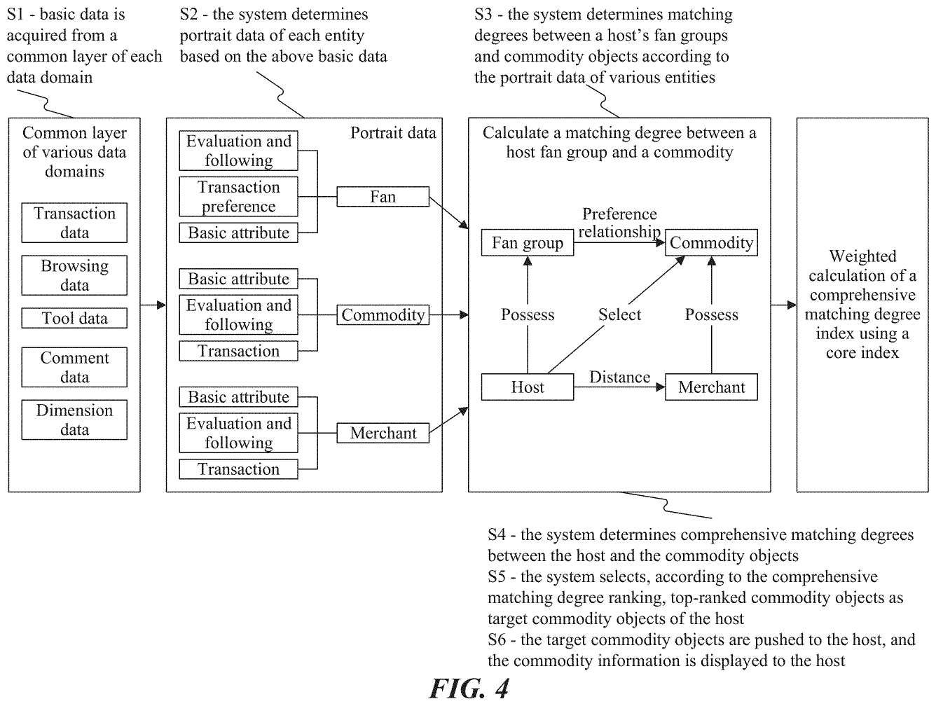

FIG. 4 is a schematic diagram of an exemplary data processing system, consistent with some embodiments of the present disclosure. The exemplary system may perform the following steps.

In step S1, basic data is acquired from a common layer of each data domain. The data of the common layer is usually basic data generated based on actual applications, and may not be processed by algorithms or data statistics. This layer may comprise user order data, commodity browsing, favoriting, comment data, commodities, commodities comprised by merchants, and basic data for merchant registration and operation, such as commodity name, commodity ID, price, merchant name, merchant ID, category, and brand. The basic data of the common layer is classified into two categories: user interaction behavior data and data of various entities. The user interaction behavior data comprises commodity transaction behavior data, commodity browsing behavior data, commodity favoriting behavior data, commodity transaction evaluation data, and so on. The data of various entities comprises fan user data, host user data, merchant user data, commodity object data, and so on.

In step S2, the system determines portrait data of each entity based on the above basic data, such as fan users' evaluation and following information, transaction preference information (commodity category preference information, commodity price preference information, commodity function preference information, and so on), and basic attributes (static attributes, and so on), such as basic attributes, evaluation and following, and transaction statistical data of commodity objects, and basic attributes, evaluation and following, and transaction statistical data of merchant users.

In step S3, the system determines matching degrees between a host's fan groups and commodity objects according to the portrait data of various entities, including determining a preference relationship between the fan groups and the commodity objects, distance relationships between the host and the merchants, and so on.

In step S4, the system determines comprehensive matching degrees between the host and the commodity objects according to the matching degrees between various entities, commodity quality scores, merchant quality scores, and so on.

In step S5, the system selects, according to the comprehensive matching degree ranking, top-ranked commodity objects as target commodity objects of the host.

In step S6, the target commodity objects are pushed to the host, and the commodity information is displayed to the host, so that the host may manually select a commodity.

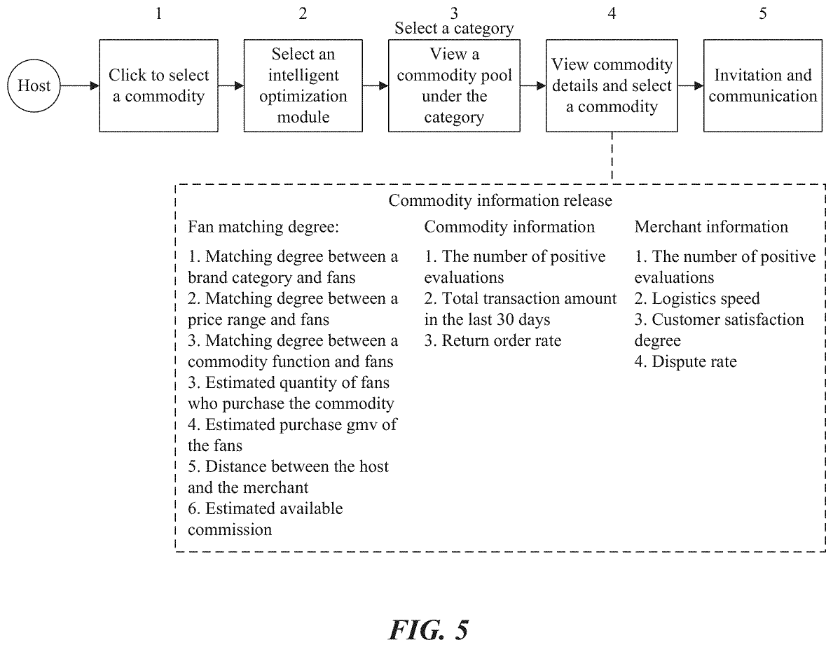

FIG. 5 is a schematic diagram of an exemplary data processing system, consistent with some embodiments of the present disclosure.

A host user may click a “select a commodity” operation option through a user interface of a client terminal provided by the system. The system responds to the operation and performs the above commodity selection processing through an “intelligent optimization module” to automatically select target commodity objects that match fan user rights of the host and are suitable for the host, and displays the commodity selection result in a client terminal of the host user. The host user may view automatic commodity selection results of various commodity categories, and click on each target commodity object to view its manual commodity selection parameter information, including a fan matching degree, commodity information, merchant information, and so on. The fan matching degree may comprise a matching degree between a brand category and fans, a matching degree between a price range and fans, a matching degree between a commodity function and fans, estimated quantity of fans who purchase the commodity, estimated total sales amount generated by the fans, a distance between the host and the merchant, estimated commission the host may gain, and so on. The commodity information may comprise the number of positive evaluations, a total transaction amount in the past 30 days, and a return order rate. The merchant information may comprise the number of positive evaluations, logistics speed, customer satisfaction degree, a dispute rate, and so on. Based on the above manual commodity selection parameter information, the host conducts a secondary screening on the target commodity objects automatically determined by the system, and determines a final commodity object for sale. During a specific implementation, online contact with a merchant user may also be established through the system, an invitation may be initiated, and communication with the merchant may be conducted.

In an example, server terminal 1 receives a host commodity selection request for a target host user sent by a client terminal of a first user; and determines, according to the request, target commodity object information that matches the target host user.

In another example, server terminal 1 periodically determines matching target commodity object information for a host user who is about to conduct a live broadcast. For example, matching target commodity object information is determined every week for the host user who has a live broadcast schedule in the next week.

In some embodiments, a data processing method can be performed by a server of a live broadcast platform, or can be performed by any device capable of performing the method. The method comprises the following steps.

In step 1, determining first feature information of at least one second user corresponding to a first user and second feature information of to-be-selected commodity objects is performed.

In step 2, determining first matching degrees in at least one first feature dimension between a second user group and the to-be-selected commodity objects according to the first feature information and the second feature information is performed.

In step 3, determining target commodity object information corresponding to the first user at least according to the first matching degrees is performed.

In an example, the first feature information comprises commodity category preference information; the second feature information comprises commodity category information; the at least one first feature dimension comprises commodity category dimension; and one first matching degree in the commodity category dimension is determined by the following steps: determining third matching degrees between the second users and a commodity category of one to-be-selected commodity object according to the commodity category preference information; and determining the first matching degree in the commodity category dimension according to the third matching degrees.

In an example, the commodity category preference information is determined in the following manner: determining the commodity category preference information according to historical interaction behavior information of the second user.

In an example, the historical interaction behavior information comprises: commodity object purchase behavior information, commodity object browsing behavior information, commodity object favoriting behavior information, and commodity object evaluation behavior information.

In an example, the determining the first matching degree in the commodity category dimension according to the third matching degrees comprises: using an average value of the third matching degrees as the first matching degree in the commodity category dimension.

In an example, the detennining the first matching degree in the commodity category dimension according to the third matching degrees comprises: determining the quantity of second users whose third matching degrees are greater than a third matching degree threshold; and using a ratio of the quantity of the second users to the quantity of all second users as the first matching degree in the commodity category dimension.

In an example, the first feature information comprises commodity price preference information for different commodity categories; the second feature information comprises commodity price information; the at least one first feature dimension comprises a commodity price dimension; and one first matching degree in the commodity price dimension is determined in the following manner: determining the first matching degree in the commodity price dimension according to the commodity price preference information of the second users for a commodity category to which one commodity object belongs and the commodity price information of the commodity object.

In an example, the commodity price preference information is determined in the following manner: determining the commodity price preference information according to the historical interaction behavior information of the second users.

In an example, the determining the first matching degrees in the price dimension according to the commodity price preference information of the second users for a commodity category to which one commodity object belongs and the commodity price information of the commodity object comprises: determining the quantity of second users whose commodity price preference information matches the commodity price information; and using a ratio of the quantity of the second users to the quantity of all second users as the first matching degree in the commodity price dimension.

In an example, the first feature information comprises commodity function preference information for different commodity categories; the second feature information comprises commodity function information; the at least one first feature dimension comprises a commodity function dimension; and one first matching degree in the commodity function dimension is determined in the following manner: determining the first matching degree in the commodity function dimension according to the commodity function preference information of the second users for a commodity category to which one commodity object belongs and the commodity function information of the commodity object.

In an example, the commodity function preference information is determined in the following manner: determining the commodity function preference information according to historical interaction behavior information of the second users.

In an example, the historical interaction behavior information comprises commodity object evaluation behavior information.

In an example, the determining the first matching degree in the commodity function dimension according to the commodity function preference information of the second users for a commodity category to which one commodity object belongs and the commodity function information of the commodity object comprises: determining the quantity of second users whose commodity function preference information matches the commodity function information; and using a ratio of the quantity of the second users to the quantity of all second users as the first matching degree in the commodity function dimension.

In an example, the method further comprises: determining third feature information of the first user and fourth feature information of third users corresponding to the commodity objects; and determining second matching degrees in at least one second feature dimension between the first user and the third users according to the third feature information and the fourth feature information. The determining the target commodity object information corresponding to the first user at least according to the first matching degrees comprises: determining the target commodity object information at least according to the first matching degrees and the second matching degrees.

In an example, the third feature information comprises: geographic location information; the fourth feature information comprises: geographic location information; the at least one second feature dimension comprises a distance dimension; and one second matching degree in the distance dimension is determined by the following step: determining the second matching degree in the distance dimension according to the geographic location information of the first user and the geographic location information of the third users.

In an example, the method further comprises: determining quality information of the commodity objects and quality information of the third users. The determining the target commodity object information at least according to the first matching degrees and the second matching degrees comprises: determining the target commodity object information according to the first matching degrees, the second matching degrees, the quality information of the commodity objects, and the quality information of the third users.

In an example, the quality information of one commodity object comprises the number of positive evaluations for the commodity.

In an example, the quality information of one third user comprises: the number of user's positive evaluations, logistics service quality information, customer service quality information, and a transaction dispute rate.

In an example, the logistics service quality information comprises an average goods delivery time length; and the customer service quality information comprises an average service response time length.

In an example, the determining the target commodity object information according to the first matching degrees, the second matching degrees, the quality information of the commodity objects, and the quality information of the third users comprises: determining third matching degrees between the first user and the commodity objects according to the first matching degrees in the at least one first feature dimension, the second matching degrees in the at least one second feature dimension, the quality information of the commodity objects, and the quality information of the third users; and determining the target commodity object information according to the third matching degrees.

In an example, the third matching degrees are determined in the following manner: according to weights of commodity selection parameters, using weighted values of the first matching degrees in the at least one first feature dimension, the second matching degrees in the at least one second feature dimension, the quality information of the commodity objects, and the quality information of the third users as the third matching degrees.

In an example, the method further comprises: determining manual commodity selection parameter information of a target commodity object; and sending the manual commodity selection parameter information to a client terminal of the first user for manual commodity selection by the first user according to the manual commodity selection parameter information.

In an example, the manual commodity selection parameter information comprises: the first matching degree, commodity sales forecast information, commodity object information, and third user information.

In an example, the commodity object information comprises: commodity static attribute information, the number of positive evaluations for the commodity, and transaction statistical data.

In an example, the third user information comprises: user static attribute information, the number of user's positive evaluations, transaction statistical data, logistics service quality information, and customer service quality information.

In an example, the transaction statistical data comprises: the quantity of commodity transactions within a target time range, the quantity of orders, the amount of commodity transactions, and the quantity of return orders.

In an example, the commodity sales forecast information comprises: commodity sales volume forecast information, commodity sales amount forecast information, and first user income forecast information.

In one example, the commodity sales forecast information is determined by the following steps: determining at least one target second user according to the first matching degrees; determining the sales volume forecast information according to a historical purchase quantity of each target second user for commodity objects in a commodity category to which the commodity object belongs; detennining the sales amount forecast information according to the sales volume forecast information; and determining the first user income forecast information according to the sales amount forecast information.

A data processing apparatus is provided. The data processing apparatus may comprise a feature determining unit, a matching degree determining unit, and a target commodity determining unit.

The feature determining unit is configured to determine first feature information of at least one second user corresponding to a first user and second feature information of to-be-selected commodity objects.

The matching degree determining unit is configured to determine first matching degrees in at least one first feature dimension between a second user group and the to-be-selected commodity objects according to the first feature information and the second feature information.

The target commodity determining unit is configured to determine target commodity object information corresponding to the first user at least according to the first matching degrees.

An exemplary electronic device provided in the embodiments comprises: a processor and a memory. The memory is configured to store a program for implementing a host commodity selection method, wherein after the device is powered on and the program of the method is run by the processor, the following steps are performed: determining first feature information of at least one second user corresponding to a first user and second feature information of to-be-selected commodity objects; determining first matching degrees in at least one first feature dimension between a second user group and the to-be-selected commodity objects according to the first feature information and the second feature information; and determining target commodity object information corresponding to the first user at least according to the first matching degrees.

In some embodiments, an exemplary data processing method can be performed by a host client terminal. The method comprises the following steps.

In step 1, receiving target commodity object information for a target first user and sent by a server terminalis performed.

In step 2, displaying the target commodity object information for manual commodity selection by the first user is performed.

In an example, the target commodity object information comprises manual commodity selection parameter information. The manual commodity selection parameter information comprises: first matching degrees in at least one first feature dimension between a second user group corresponding to the target first user and the target commodity object, a second matching degree in at least one second feature dimension between the target first user and a third user of the target commodity object, sales forecast information of the target commodity object, commodity object information, and third user information.

A data processing apparatus is provided. The data processing apparatus can comprise a target commodity receiving unit and a target commodity display unit.

The target commodity receiving unit is configured to receive target commodity object information for a target first user and sent by a server terminal.

The target commodity display unit is configured to display the target commodity object information for manual commodity selection by the first user.

An exemplary electronic device provided in the embodiments comprises: a processor and a memory. The memory is configured to store a program for implementing a host commodity selection method, wherein after the device is powered on and the program of the method is run by the processor, the following steps are performed: receiving target commodity object information for a target first user and sent by a server terminal; and displaying the target commodity object information for manual commodity selection by the first user.

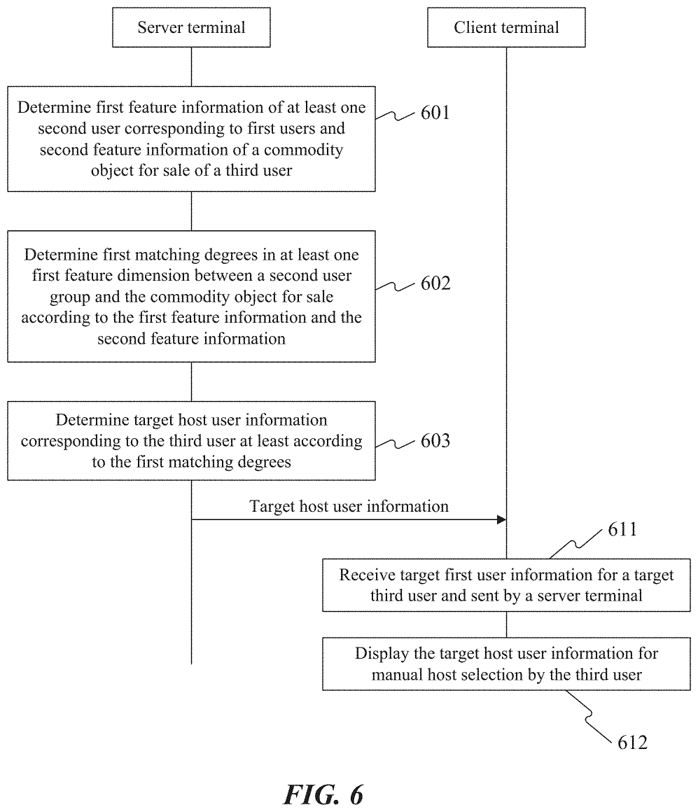

FIG. 6 is a schematic diagram of an exemplary data processing process, consistent with some embodiments of the present disclosure. A server is configured to determine first feature information of at least one second user corresponding to a first user and second feature information of a commodity object for sale of a third user. The server determines first matching degrees in at least one first feature dimension between a second user group and the commodity object for sale according to the first feature information and the second feature information. After determining the first matching degrees, the server determines target first user information corresponding to the third user at least according to the first matching degrees. The client terminal is configured to receive the target first user information sent by the server terminal; and display the target first user information for manual host selection by the third user.

In an example, the first feature information includes commodity category preference information; the second feature information comprises commodity category information; the at least one first feature dimension comprises commodity category dimension; and one first matching degree in the commodity category dimension is determined by the following steps: determining third matching degrees between the second users and a commodity category of one to-be-selected commodity object according to the commodity category preference information; and determining the first matching degree in the commodity category dimension according to the third matching degrees.

The commodity category preference information may be determined in the following manner: determining the commodity category preference information according to historical interaction behavior information of the second user.

The historical interaction behavior information includes but is not limited to: commodity object purchase behavior information, commodity object browsing behavior information, commodity object favoriting behavior information, and commodity object evaluation behavior information.

The determining the first matching degree in the commodity category dimension according to the third matching degrees comprises: using an average value of the third matching degrees as the first matching degree in the commodity category dimension.

The determining the first matching degree in the commodity category dimension according to the third matching degrees may comprise the following sub-steps: 1) determining the quantity of second users whose third matching degrees are greater than a third matching degree threshold; and 2) using a ratio of the quantity of the second users to the quantity of all second users as the first matching degree in the commodity category dimension.

In another example, the first feature information comprises commodity price preference information for different commodity categories; the second feature information comprises commodity price information; the at least one first feature dimension comprises a commodity price dimension; and one first matching degree in the commodity price dimension is determined in the following manner: determining the first matching degree in the commodity price dimension according to the commodity price preference information of the second users for a commodity category to which one commodity object belongs and the commodity price information of the commodity object.

The commodity price preference information can be determined in the following manner: determining the commodity price preference information according to the historical interaction behavior information of the second user.

The determining the first matching degrees in the price dimension according to the commodity price preference information of the second users for a commodity category to which one commodity object belongs and the commodity price information of the commodity object may comprise the following sub-steps: 1) determining the quantity of second users whose commodity price preference information matches the commodity price information; and 2) using a ratio of the quantity of the second users to the quantity of all second users as the first matching degree in the commodity price dimension.

In another example, the first feature information comprises commodity function preference information for different commodity categories; the second feature information comprises commodity function information; the at least one first feature dimension comprises a commodity function dimension; and one first matching degree in the commodity function dimension is determined in the following manner: determining the first matching degree in the commodity function dimension according to the commodity function preference information of the second users for a commodity category to which one commodity object belongs and the commodity function information of the commodity object.

The commodity function preference information can be determined in the following manner: determining the commodity function preference information according to the historical interaction behavior information of the second user.

The historical interaction behavior information comprises but is not limited to commodity object evaluation behavior information.

The determining the first matching degree in the commodity function dimension according to the commodity function preference information of the second users for a commodity category to which one commodity object belongs and the commodity function information of the commodity object may comprise the following sub-steps: 1) determining the quantity of second users whose commodity function preference information matches the commodity function information; and 2) using a ratio of the quantity of the second users to the quantity of all second users as the first matching degree in the commodity function dimension.

In some embodiments, the server may also be configured to determine third feature information of the first user and fourth feature information of the third user; and determining a second matching degree in at least one second feature dimension between the first user and the third user according to the third feature information and the fourth feature information. The determining the target first user information corresponding to the third user at least according to the first matching degrees comprises: determining the target first user information at least according to the first matching degrees and the second matching degree.

In an example, the third feature information comprises geographic location information; the fourth feature information comprises geographic location information; the at least one second feature dimension comprises: a distance dimension; and the second matching degree in the distance dimension can be determined by the following step: determining the second matching degree in the distance dimension according to the geographic location information of the first user and the geographic location information of the third user.

In an example, the server terminal may also be configured to determine quality information of the first user. The determining the target first user information at least according to the first matching degrees and the second matching degree can be implemented in the following manner: determining the target first user information according to the first matching degree, the second matching degree, and the quality information of the first user.

The quality information of one first user comprises but is not limited to: the number of user's positive evaluations and fan user quality information. The fan user quality information comprises but is not limited to: a transaction dispute rate and a return rate.

In an example, the determining the target first user information according to the first matching degrees, the second matching degrees, and the quality information of the first users may comprise the following sub-steps: 1) determining third matching degrees between the first users and the commodity object according to the first matching degrees in the at least one first feature dimension, the second matching degrees in the at least one second feature dimension, and the quality information of the first users; and 2) determining the target first user information according to the third matching degrees.

In some embodiments, the third matching degree can be determined in the following manner: according to parameter weights, using weighted values of the first matching degree in the at least one first feature dimension, the second matching degree in the at least one second feature dimension, and the quality information of the first user as the third matching degrees.

In some embodiments, an exemplary data processing method can be performed by a server of a live broadcast platform, or can be performed by any device capable of performing the method. The method comprises the following steps.

In step 601, determining first feature information of at least one second user corresponding to first users and second feature information of a commodity object for sale of a third user is performed.

In step 602, determining first matching degrees in at least one first feature dimension between a second user group and the to-be-sold commodity objects according to the first feature information and the second feature information is performed.

In step 603, determining target first user information corresponding to the third user at least according to the first matching degrees is performed.

A data processing apparatus is provided. The data processing apparatus may comprise a feature determining unit, a matching degree determining unit, and a target user determining unit.

The feature determining unit is configured to determine first feature information of at least one second user corresponding to first users and second feature information of a commodity object for sale of a third user.

The matching degree determining unit is configured to determine first matching degrees in at least one first feature dimension between a second user group and the commodity object for sale according to the first feature information and the second feature information.

The target user determining unit is configured to determine target first user information corresponding to the third user at least according to the first matching degrees.

An exemplary electronic device provided in the embodiments comprises: a processor and a memory. The memory is configured to store a program for implementing a host determination method, wherein after the device is powered on and the program of the method is run by the processor, the following steps are performed: determining first feature information of at least one second user corresponding to a first user and second feature information of a commodity object for sale of a third user; determining first matching degrees in at least one first feature dimension between a second user group and the commodity object for sale according to the first feature information and the second feature information; and determining target first user information corresponding to the third user at least according to the first matching degrees.

In some embodiments, an exemplary data processing method can be performed by a client terminal of a merchant. The method comprises the following steps.

In step 611, receiving target first user information for a target third user and sent by a server terminal is performed.

In step 612, displaying the target first user information for manual host selection by the third user is performed.

A data processing apparatus is provided. The data processing apparatus may comprise a target user receiving unit configured to receive target first user information for a target third user and sent by a server terminal; and a target user receiving unit configured to display the target first user information for manual host selection by the third user.

An exemplary electronic device provided in the embodiments comprises: a processor and a memory. The memory is configured to store a program for implementing a host determination method, wherein after the device is powered on and the program of the method is run by the processor, the following steps are performed: receiving target first user information for a target third user and sent by a server terminal; and displaying the target first user information for manual host selection by the third user.

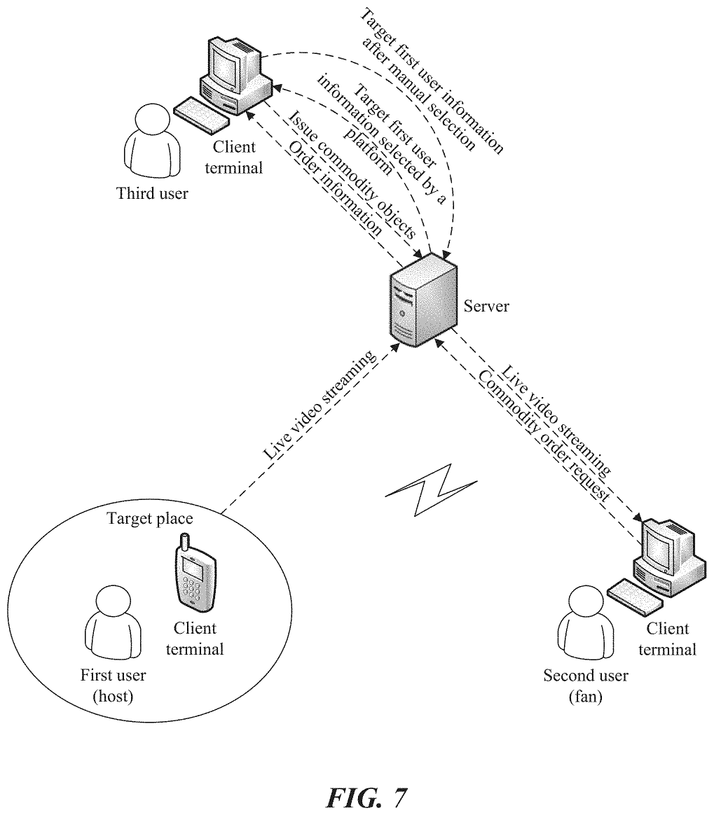

FIG. 7 is a schematic diagram of an exemplary data processing system, consistent with some embodiments of the present disclosure.

A first user is located in a target place, and a third user (a commodity seller) in the target place issues a commodity object intended to be sold by a host to a commodity object pool of the system as a to-be-selected commodity object. Server terminal 1 determines multiple first users located in the target place, determines, based at least on a portrait of a second user group (a fan user group) corresponding to the first user and a portrait of the to-be-selected commodity object, association relationships between the second user group and various entities in a host determination scenario such as the to-be-selected commodity object, and in consideration of a matching degree between each other, selects a host whose fan group is suitable for the commodity object for sale for the merchant. Client terminal 2 displays target host user information selected by the system, and the third user manually selects a host according to the information. The first user conducts live sales of the commodity object of the third user on a live broadcast platform through his/her client terminal. At the same time, a second user watches the live program through his/her client terminal, and may purchase the commodity being sold by the host while watching the commodity sales live program. Server terminal 1 may receive a commodity order request of the second user, generate order information, and send it to a client terminal of the third user. The third user performs order fulfillment processing according to the order information.

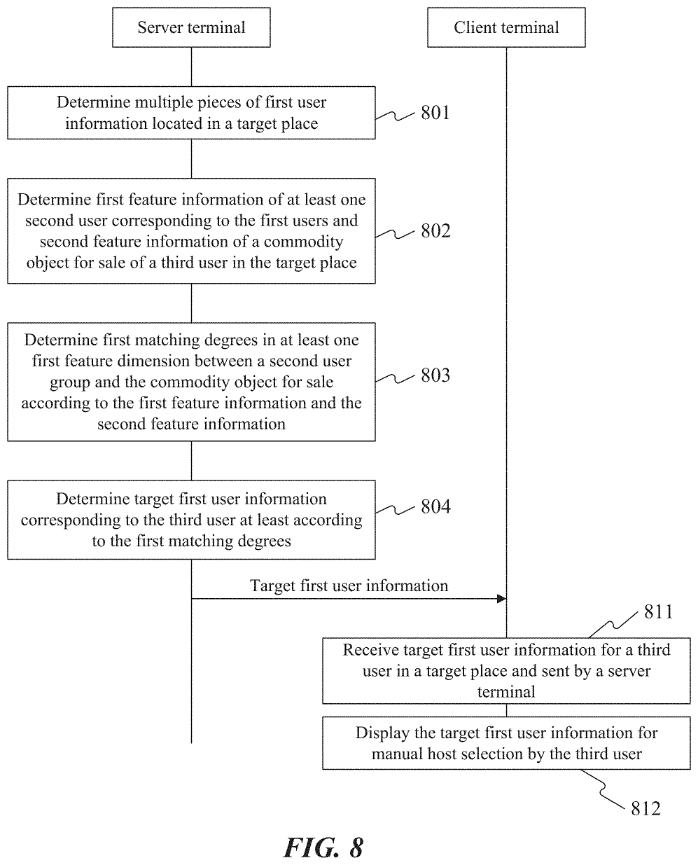

FIG. 8 is a schematic diagram of an exemplary data processing process, consistent with some embodiments of the present disclosure. A server is configured to determine multiple pieces of first user information located in a target place; determine first feature information of at least one second user corresponding to the first user and second feature information of a commodity object for sale of a third user in the target place; determine first matching degrees in at least one first feature dimension between a second user group and the commodity object for sale according to the first feature information and the second feature information; and determine target first user information corresponding to the third user at least according to the first matching degrees. A client terminal is configured to receive the target first user information sent by the server terminal; and display the target first user information for the third user to manually determine a host who sells the commodity object in a live broadcast manner.

The target place comprises but is not limited to a shopping place (such as a shopping mall and a supermarket), a tourist place (such as a museum and a park), a restaurant, and so on. The third user may be a manager of the target place, such as a museum or park manager; or a merchant that specializes in selling commodities in the target place, such as an operator of a restaurant in a park.

For example, the target place is a restaurant, and the commodity object for sale is a certain “grilled fish” meal recommended by the restaurant, then the first user who is eating the “grilled fish” meal in the restaurant becomes a potential host user. Further, if most fans of the first user prefer grilled fish meals, the first user can be regarded as the target first user determined by the system and pushed to the third user for the third user to manually determine whether to finally regard the first user as a host user.

For another example, the target place is a bookstore, the bookstore is holding a new book release conference, and the commodity object for sale is the new book, then the first user who is participating in the release conference becomes a potential host user. Further, if most fans of the first user prefer this type of book, the first user can be regarded as the target first user determined by the system and pushed to the third user for the third user to manually determine whether to finally regard the first user as a host user.

For another example, the target place is an amusement park, and the commodity object for sale is a ticket of the amusement park, then the first user who is playing in the amusement park becomes a potential host user. Further, if most fans of the first user are young people who prefer the entertainment of playing in an amusement park, the first user can be regarded as the target first user determined by the system and pushed to the third user for the third user to manually determine whether to finally regard the first user as a host user.

In an example, the first feature information comprises commodity category preference information; the second feature information comprises commodity category information; the at least one first feature dimension comprises commodity category dimension; and one first matching degree in the commodity category dimension is determined by the following steps: determining third matching degrees between the second users and a commodity category of one to-be-selected commodity object according to the commodity category preference information; and determining the first matching degree in the commodity category dimension according to the third matching degrees. The commodity category preference information can be determined in the following manner: determining the commodity category preference information according to historical interaction behavior information of the second user.

The historical interaction behavior information comprises but is not limited to: commodity object purchase behavior information, commodity object browsing behavior information, commodity object favoriting behavior information, and commodity object evaluation behavior information.

The determining the first matching degree in the commodity category dimension according to the third matching degrees comprises: using an average value of the third matching degrees as the first matching degree in the commodity category dimension.

The determining the first matching degree in the commodity category dimension according to the third matching degrees may comprise the following sub-steps: 1) determining the quantity of second users whose third matching degrees are greater than a third matching degree threshold; and 2) using a ratio of the quantity of the second users to the quantity of all second users as the first matching degree in the commodity category dimension.

In another example, the first feature information comprises commodity price preference information for different commodity categories; the second feature information comprises commodity price information; the at least one first feature dimension comprises a commodity price dimension; and one first matching degree in the commodity price dimension is determined in the following manner: determining the first matching degree in the commodity price dimension according to the commodity price preference information of the second users for a commodity category to which one commodity object belongs and the commodity price information of the commodity object.

The commodity price preference information can be determined in the following manner: determining the commodity price preference information according to the historical interaction behavior information of the second user.

The determining the first matching degrees in the price dimension according to the commodity price preference information of the second users for a commodity category to which one commodity object belongs and the commodity price information of the commodity object may comprise the following sub-steps: 1) determining the quantity of second users whose commodity price preference information matches the commodity price information; and 2) using a ratio of the quantity of the second users to the quantity of all second users as the first matching degree in the commodity price dimension.

In another example, the first feature information comprises commodity function preference information for different commodity categories; the second feature information comprises commodity function information; the at least one first feature dimension comprises a commodity function dimension; and one first matching degree in the commodity function dimension is determined in the following manner: determining the first matching degree in the commodity function dimension according to the commodity function preference information of the second users for a commodity category to which one commodity object belongs and the commodity function information of the commodity object.

The commodity function preference information can be determined in the following manner: determining the commodity function preference information according to the historical interaction behavior information of the second user.

The historical interaction behavior information comprises but is not limited to commodity object evaluation behavior information.

The determining the first matching degree in the commodity function dimension according to the commodity function preference information of the second users for a commodity category to which one commodity object belongs and the commodity function information of the commodity object may comprise the following sub-steps: 1) determining the quantity of second users whose commodity function preference information matches the commodity function information; and 2) using a ratio of the quantity of the second users to the quantity of all second users as the first matching degree in the commodity function dimension.

In some embodiments, the server terminal may also be configured to determine third feature information of the first user and fourth feature information of the third user; and determine a second matching degree in at least one second feature dimension between the first user and the third user according to the third feature information and the fourth feature information. The determining the target first user information corresponding to the third user at least according to the first matching degrees comprises: determining the target first user information at least according to the first matching degrees and the second matching degree.

In an example, the server terminal may also be configured to determine quality information of the first user. The determining the target first user information at least according to the first matching degrees and the second matching degree may be implemented in the following manner: determining the target first user information according to the first matching degree, the second matching degree, and the quality information of the first user.

The quality information of one first user comprises but is not limited to: the number of user's positive evaluations, and fan user quality information. The fan user quality information comprises but is not limited to: a transaction dispute rate and a return rate.

In an example, the determining the target first user information according to the first matching degrees, the second matching degrees, and the quality information of the first users may comprise the following sub-steps: 1) determining third matching degrees between the first users and the commodity object according to the first matching degrees in the at least one first feature dimension, the second matching degrees in the at least one second feature dimension, and the quality information of the first users; and 2) determining the target first user information according to the third matching degrees.

In some embodiments, the third matching degree can be determined in the following manner: according to parameter weights, using weighted values of the first matching degree in the at least one first feature dimension, the second matching degree in the at least one second feature dimension, and the quality information of the first user as the third matching degree.

An exemplary system determines, by a server, multiple pieces of first user information in a target place; determines first feature information of at least one second user corresponding to the first user and second feature information of a commodity object for sale of a third user in the target place; determines first matching degrees in at least one first feature dimension between a second user group and the commodity object for sale according to the first feature information and the second feature information; determines target first user information corresponding to the third user at least according to the first matching degrees; and receives, by a client terminal, the target first user information sent by the server terminal, and displays the target first user information for the third user to manually determine a host who sells the commodity object in a live broadcast manner. For a first user in the site of a third user, this processing method enables the relationship between fans and commodities to be determined based on a portrait of a fan group of the user and portraits of commodities sold by merchants, and a matching degree between each other is considered to select the first user as a host whose fan group is suitable for the commodities sold by the merchant. Therefore, the host selection quality and efficiency can be effectively improved, thereby increasing the income of commodity sales. Moreover, this processing method enables the first user to sell the commodity to his/her fan group at a site of the third user by the live broadcast, and the fans can feel the live atmosphere, thus being conducive to improving the commodity transaction ratio.

An exemplary data processing method can be performed by a server of a live broadcast platform, or can be performed by any device capable of performing the method. The host determination method comprises the following steps.

In step 801, determining multiple pieces of first user information located in a target place is performed.

In step 802, determining first feature information of at least one second user corresponding to the first user and second feature information of a commodity object for sale of a third user in the target place is performed. In step 803, determining first matching degrees in at least one first feature dimension between a second user group and the commodity object for sale according to the first feature information and the second feature information is performed.

In step 804, determining target first user information corresponding to the third user at least according to the first matching degrees is performed.

The target place comprises a shopping place, a tourist place, and a restaurant.

A data processing apparatus is provided. The data processing apparatus may comprise a user positioning unit, a feature determining unit, a matching degree determining unit, and a target user determining unit.

The user positioning unit is configured to determine multiple pieces of first user information located in a target place.

The feature determining unit is configured to determine first feature information of at least one second user corresponding to the first user and second feature information of a commodity object for sale of a third user in the target place.

The matching degree determining unit is configured to determine first matching degrees in at least one first feature dimension between a second user group and the commodity object for sale according to the first feature information and the second feature information.

The target user determining unit is configured to determine target first user information corresponding to the third user at least according to the first matching degrees.

An exemplary electronic device provided in the embodiments comprises: a processor and a memory. The memory is configured to store a program for implementing a host determination method, wherein after the device is powered on and the program of the method is run by the processor, the following steps are performed: determining multiple pieces of first user information located in a target place; determining first feature information of at least one second user corresponding to a first user and second feature information of a commodity object for sale of a third user in the target place; determining first matching degrees in at least one first feature dimension between a second user group and the commodity object for sale according to the first feature information and the second feature information; and determining target first user information corresponding to the third user at least according to the first matching degrees.

An exemplary data processing method can be performed by a client terminal of a merchant. The method comprises the following steps.

In step 811, receiving target first user information for a third user in a target place and sent by a server terminal is performed.

In step 812, displaying the target first user information for the third user to manually determine a host who sells the commodity object in a live broadcast manner is performed.

A data processing apparatus is provided. The data processing apparatus may comprise a target user receiving unit configured to receive target first user information for a third user sent in a target place and sent by a server terminal; and a target user display unit configured to display the target first user information for the third user to manually determine a host who sells the commodity object in a live broadcast manner.

An exemplary electronic device provided in the embodiments comprises: a processor and a memory. The memory is configured to store a program for implementing a host determination method, wherein after the device is powered on and the program of the method is run by the processor, the following steps are performed: receiving target first user information for a third user in a target place and sent by a server terminal; and displaying the target first user information for the third user to manually determine a host who sells the commodity object in a live broadcast manner.

An exemplary data processing method can be performed by a server of a live broadcast platform, or can be performed by any device capable of performing the method. The method comprises the following steps.

In step 1, acquiring historical interaction behavior information of a second user is performed.

In step 2, determining commodity transaction preference information of the second user according to the historical interaction behavior information is performed.

The historical interaction behavior information comprises: commodity object purchase behavior information, commodity object browsing behavior information, commodity object favoriting behavior information, and commodity object evaluation behavior information.

The commodity transaction preference information comprises: commodity category preference information, commodity price preference information for different commodity categories, and commodity function preference information for different commodity categories.

An exemplary data processing method can be performed by a server of a live broadcast platform, or can be performed by any device capable of performing the method. The method comprises the following steps.

In step 1, acquiring historical live sales behavior information of a first user is performed.

In step 2, determining commodity sales preference information of the first user according to the behavior information is performed.

The commodity sales preference information comprises commodity category preference information.

An exemplary data processing method can be performed by a server of a live broadcast platform, or performed by any device capable of performing the method. The method comprises the following steps.

In step 1, determining first feature information of at least one second user corresponding to a first user and second feature information of to-be-selected commodity objects is performed.

In step 2, determining a first degree of difference in at least one first feature dimension between a second user group and the to-be-selected commodity objects according to the first feature information and the second feature information is performed.

In step 3, filtering out, at least according to the first degree of difference, a commodity object among the to-be-selected commodity objects that does not correspond to the first user is performed.

In step 4, using the to-be-selected commodity object after the filtering-out as a target commodity object corresponding to the first user is performed.

An exemplary data processing method can be performed by a server of a live broadcast platform, or performed by any device capable of performing the method. The method comprises the following steps.

In step 1, determining commodity sales exclusion information of a first user and feature information of a to-be-selected commodity object is performed.

In step 2, determining a first degree of difference between the first user and the to-be-selected commodity object according to the exclusion information and the feature information is performed.

In step 3, filtering out, at least according to the first degree of difference, a commodity object among the to-be-selected commodity objects that does not correspond to the first user is performed.

In step 4, using the to-be-selected commodity object after the filtering-out as a target commodity object corresponding to the first user is performed.

The commodity sales exclusion information comprises: commodity category exclusion information, commodity price exclusion information, commodity function exclusion information, and merchant geographical region exclusion information.

The feature information comprises: commodity category information, commodity price information, commodity function information, and merchant geographical region information.

It is appreciated that terms “first,” “second,” and so on used in the specification, claims, and the drawings of the present disclosure are used to distinguish similar objects. These terms do not necessarily describe a particular order or sequence. The objects described using these terms can be interchanged in appropriate circumstances. That is, the procedures described in the exemplary embodiments of the present disclosure could be implemented in an order other than those shown or described herein. In addition, terms such as “comprise,” “include,” and “have” as well as their variations are intended to cover non-exclusive inclusion. For example, a process, method, system, product, or device including a series of steps or units are not necessarily limited to the steps or units clearly listed. In some embodiments, they may comprise other steps or units that are not clearly listed or inherent to the process, method, product, or device.

As used herein, unless specifically stated otherwise, the term “or” encompasses all possible combinations, except where infeasible. For example, if it is stated that a device may comprise A or B, then, unless specifically stated otherwise or infeasible, the device may comprise A, or B, or A and B. As a second example, if it is stated that a device may comprise A, B, or C, then, unless specifically stated otherwise or infeasible, the device may comprise A, or B, or C, or A and B, or A and C, or B and C, or A and B and C.

The disclosed embodiments may further be described using the following clauses:
1. A data processing method, comprising:
determining first feature information of one or more second users corresponding to a first user and second feature information of one or more to-be-selected commodity objects;
determining one or more first matching degrees in at least one first feature dimension between the one or more second users and the one or more to-be-selected commodity objects according to the first feature information and the second feature information; and
determining target commodity object information corresponding to the first user according to the one or more first matching degrees.
2. The method according to clause 1, wherein
the first feature information comprises commodity category preference information;
the second feature information comprises commodity category information;
the at least one first feature dimension comprises a commodity category dimension; and
one first matching degree in the commodity category dimension among the one or more first matching degrees is determined by the following:
determining third matching degrees between the one or more second users and a commodity category of one to-be-selected commodity object according to the commodity category preference information; and
determining the first matching degree in the commodity category dimension according to the third matching degrees.
3. The method according to clause 2, wherein the commodity category preference information is determined according to historical interaction behavior information of the second user.
4. The method according to clause 3, wherein
the historical interaction behavior information comprises: commodity object purchase behavior information, commodity object browsing behavior information, commodity object favoriting behavior information, and commodity object evaluation behavior information.
5. The method according to clause 2, wherein determining the first matching degree in the commodity category dimension according to the third matching degrees comprises:
using an average value of the third matching degrees as the first matching degree in the commodity category dimension.
6. The method according to clause 2, wherein determining the first matching degree in the commodity category dimension according to the third matching degrees comprises:
determining the quantity of second users whose third matching degrees are greater than a third matching degree threshold; and
using a ratio of the quantity of the second users to the quantity of all second users as the first matching degree in the commodity category dimension.
7. The method according to clause 1, wherein
the first feature information comprises commodity price preference information for a plurality of commodity categories;
the second feature information comprises commodity price information;
the at least one first feature dimension comprises commodity price dimension; and
one first matching degree in the commodity price dimension among the one or more first matching degrees is determined according to the commodity price preference information of the one or more second users for a commodity category to which one commodity object belongs and the commodity price information of the one commodity object.
8. The method according to clause 7, wherein the commodity price preference information is determined by:
determining the commodity price preference information according to historical interaction behavior information of the second users.
9. The method according to clause 7, wherein determining the first matching degree in the price dimension according to the commodity price preference information of the second users for a commodity category to which one commodity object belongs and the commodity price information of the commodity object comprises:
determining the quantity of second users whose commodity price preference information matches the commodity price information; and
using a ratio of the quantity of the second users to the quantity of all second users as the first matching degree in the commodity price dimension.
10. The method according to clause 1, wherein
the first feature information comprises commodity function preference information for a plurality of commodity categories;
the second feature information comprises commodity function information;
the at least one first feature dimension comprises commodity function dimension; and
one first matching degree in the commodity function dimension among the one or more first matching degrees is determined according to the commodity function preference information of the one or more second users for a commodity category to which one commodity object belongs and the commodity function information of the one commodity object.
11. The method according to clause 10, wherein the commodity function preference information is determined by:
determining the commodity function preference information according to historical interaction behavior information of the second users.
12. The method according to clause 11, wherein
the historical interaction behavior information comprises commodity object evaluation behavior information.
13. The method according to clause 10, wherein determining the first matching degree in the commodity function dimension according to the commodity function preference information of the second users for a commodity category to which one commodity object belongs and the commodity function information of the commodity object comprises:
determining the quantity of second users whose commodity function preference information matches the commodity function information; and
using a ratio of the quantity of the second users to the quantity of all second users as the first matching degree in the commodity function dimension.
14. The method according to clause 1, further comprising:
determining third feature information of the first user and fourth feature information of one or more third users corresponding to the commodity objects; and
determining one or more second matching degrees in at least one second feature dimension between the first user and the one or more third users according to the third feature information and the fourth feature information;
wherein determining the target commodity object information corresponding to the first user according to the one or more first matching degrees comprises:
determining the target commodity object information according to the one or more first matching degrees and the one or more second matching degrees.
15. The method according to clause 14, wherein
the third feature information comprises geographic location information;
the fourth feature information comprises geographic location information;
the at least one second feature dimension comprises a distance dimension; and
one second matching degree in the distance dimension among the one or more second matching degrees is determined according to the geographic location information of the first user and the geographic location information of one third user.
16. The method according to clause 14, further comprising:
determining quality information of the commodity objects and quality information of the third users; and
determining the target commodity object information at least according to the first matching degrees and the second matching degrees comprises:
determining the target commodity object information according to the first matching degrees, the second matching degrees, the quality information of the commodity objects, and the quality information of the third users.
17. The method according to clause 16, wherein
the quality information of one commodity object comprises a number of positive evaluations for the commodity.
18. The method according to clause 16, wherein
the quality information of one third user comprises the number of user's positive evaluations, logistics service quality information, customer service quality information, and a transaction dispute rate.
19. The method according to clause 18, wherein
the logistics service quality information comprises an average goods delivery time length; and
the customer service quality information comprises an average service response time length.
20. The method according to clause 16, wherein determining the target commodity object information according to the first matching degrees, the second matching degrees, the quality information of the commodity objects, and the quality information of the third users comprises:
determining third matching degrees between the first user and the commodity objects according to the first matching degrees in the at least one first feature dimension, the second matching degrees in the at least one second feature dimension, the quality information of the commodity objects, and the quality information of the third users; and
determining the target commodity object information according to the third matching degrees.
21. The method according to clause 20, wherein the third matching degrees are determined by:
according to weights of commodity selection parameters, using weighted values of the first matching degrees in the at least one first feature dimension, the second matching degrees in the at least one second feature dimension, the quality information of the commodity objects, and the quality information of the third users, as the third matching degrees.
22. The method according to clause 1, further comprising:
determining manual commodity selection parameter information of a target commodity object; and
sending the manual commodity selection parameter information to a client terminal of the first user for manual commodity selection by the first user according to the manual commodity selection parameter information.
23. The method according to clause 22, wherein the manual commodity selection parameter information comprises:
the first matching degree, commodity sales forecast information, commodity object information, and third user information.
24. The method according to clause 23, wherein
the commodity object information comprises: commodity static attribute information, the number of positive evaluations for the commodity, and transaction statistical data.
25. The method according to clause 23, wherein
the third user information comprises: user static attribute information, the number of user's positive evaluations, transaction statistical data, logistics service quality information, and customer service quality information.
26. The method according to any one of clause 24 or 25, wherein
the transaction statistical data comprises: the quantity of commodity transactions within a target time range, the quantity of orders, the amount of commodity transactions, and the quantity of return orders.
27. The method according to clause 23, wherein
the commodity sales forecast information comprises: commodity sales volume forecast information, commodity sales amount forecast information, and first user income forecast information.
28. The method according to clause 23, wherein the commodity sales forecast information is determined by:
determining at least one target second user according to the first matching degrees;
determining the sales volume forecast information according to a historical purchase quantity of each target second user for commodity objects in a commodity category to which the commodity object belongs;
determining the sales amount forecast information according to the sales volume forecast information; and
determining the first user income forecast information according to the sales amount forecast information.
29. A method comprising:
receiving target commodity object information for a target first user from a server; and
displaying the target commodity object information for manual commodity selection.
30. The method according to clause 29, wherein
the target commodity object information comprises manual commodity selection parameter information; and
the manual commodity selection parameter information comprises:
first matching degrees in at least one first feature dimension between a second user group corresponding to the target first user and the target commodity object, a second matching degree in at least one second feature dimension between the target first user and a third user of the target commodity object, sales forecast information of the target commodity object, commodity object information, and third user information.
31. A method comprising:
determining first feature information of at least one second user corresponding to first users and second feature information of a commodity object for sale of a third user;
determining first matching degrees in at least one first feature dimension between a second user group and the commodity object for sale according to the first feature information and the second feature information; and determining target first user information corresponding to the third user at least according to the first matching degrees.
32. A method comprising:
receiving target first user information for a target third user from a server terminal; and
displaying the target first user information for manual host selection by the third user.
33. A method comprising:
acquiring historical interaction behavior information of a second user; and
determining commodity transaction preference information of the second user according to the historical interaction behavior information.
34. The method according to clause 33, wherein
the historical interaction behavior information comprises: commodity object purchase behavior information, commodity object browsing behavior information, commodity object favoriting behavior information, and commodity object evaluation behavior information.
35. The method according to clause 33, wherein
the commodity transaction preference information comprises: commodity category preference information, commodity price preference information for different commodity categories, and commodity function preference information for different commodity categories.
36. A method comprising:
acquiring historical live sales behavior information of a first user; and
determining commodity sales preference information of the first user according to the behavior information.
37. The method according to clause 36, wherein
the commodity sales preference information comprises commodity category preference information.
38. A method comprising:
determining first feature information of at least one second user corresponding to a first user and second feature information of to-be-selected commodity objects;
determining a first degree of difference in at least one first feature dimension between a second user group and the to-be-selected commodity objects according to the first feature information and the second feature information;
filtering out, at least according to the first degree of difference, a commodity object among the to-be-selected commodity objects that does not correspond to the first user; and
using the to-be-selected commodity object after the filtering-out as a target commodity object corresponding to the first user.
39. A method comprising:
determining commodity sales exclusion information of a first user and feature information of to-be-selected commodity objects;
determining a first degree of difference between the first user and the to-be-selected commodity objects according to the exclusion information and the feature information;
filtering out, at least according to the first degree of difference, a commodity object among the to-be-selected commodity objects that does not correspond to the first user; and
using the to-be-selected commodity object after the filtering-out as a target commodity object corresponding to the first user.
40. The method according to clause 39, wherein
the commodity sales exclusion information comprises: commodity category exclusion information, commodity price exclusion information, commodity function exclusion information, and merchant geographical region exclusion information; and
the feature information comprises: commodity category information, commodity price information, commodity function information, and merchant geographical region information.
41. A method comprising:
determining a plurality pieces of first user information located in a target place;
determining first feature information of at least one second user corresponding to the first users and second feature information of a commodity object for sale of a third user in the target place;
determining first matching degrees in at least one first feature dimension between a second user group and the commodity object for sale according to the first feature information and the second feature information; and
determining target first user information corresponding to the third user among the plurality of pieces of first user information according to the first matching degrees.
42. The method according to clause 41, wherein
the target place comprises a shopping place, a tourist place, and a restaurant.
43. A method comprising:
receiving target first user information for a third user in a target place from a server; and
displaying the target first user information for the third user to determine a host for live broadcast sales of commodity objects.
44. A data processing apparatus, comprising:
a memory storing a set of instructions; and
one or more processors configured to execute the set of instructions to cause the apparatus to perform:
determining first feature information of one or more second users corresponding to a first user and second feature information of one or more to-be-selected commodity objects;
determining one or more first matching degrees in at least one first feature dimension between the one or more second users and the one or more to-be-selected commodity objects according to the first feature information and the second feature information; and
determining target commodity object information corresponding to the first user according to the one or more first matching degrees.
45. The apparatus of clause 44, wherein the one or more processors configured to execute the set of instructions to cause the apparatus to further perform:
the first feature information comprises commodity category preference information;
the second feature information comprises commodity category information;
the at least one first feature dimension comprises a commodity category dimension; and
one first matching degree in the commodity category dimension among the one or more first matching degrees is determined by the following:
determining third matching degrees between the one or more second users and a commodity category of one to-be-selected commodity object according to the commodity category preference information; and
determining the first matching degree in the commodity category dimension according to the third matching degrees.
46. The apparatus of clause 45, wherein the commodity category preference information is determined according to historical interaction behavior information of the second user.
47. The apparatus of clause 46, wherein
the historical interaction behavior information comprises: commodity object purchase behavior information, commodity object browsing behavior information, commodity object favoriting behavior information, and commodity object evaluation behavior information.
48. The apparatus of clause 45, wherein determining the first matching degree in the commodity category dimension according to the third matching degrees comprises:
using an average value of the third matching degrees as the first matching degree in the commodity category dimension.
49. The apparatus of clause 45, wherein determining the first matching degree in the commodity category dimension according to the third matching degrees comprises:
determining the quantity of second users whose third matching degrees are greater than a third matching degree threshold; and
using a ratio of the quantity of the second users to the quantity of all second users as the first matching degree in the commodity category dimension.
50. The apparatus of clause 44, wherein
the first feature information comprises commodity price preference information for a plurality of commodity categories;
the second feature information comprises commodity price information;
the at least one first feature dimension comprises commodity price dimension; and
one first matching degree in the commodity price dimension among the one or more first matching degrees is determined according to the commodity price preference information of the one or more second users for a commodity category to which one commodity object belongs and the commodity price information of the one commodity object.
51. The apparatus of clause 50, wherein the commodity price preference information is determined by:
determining the commodity price preference information according to historical interaction behavior information of the second users.
52. The apparatus of clause 50, wherein determining the first matching degree in the price dimension according to the commodity price preference information of the second users for a commodity category to which one commodity object belongs and the commodity price information of the commodity object comprises:
determining the quantity of second users whose commodity price preference information matches the commodity price information; and
using a ratio of the quantity of the second users to the quantity of all second users as the first matching degree in the commodity price dimension.
53. The apparatus of clause 44, wherein
the first feature information comprises commodity function preference information for a plurality of commodity categories;
the second feature information comprises commodity function information;
the at least one first feature dimension comprises commodity function dimension; and
one first matching degree in the commodity function dimension among the one or more first matching degrees is determined according to the commodity function preference information of the one or more second users for a commodity category to which one commodity object belongs and the commodity function information of the one commodity object.
54. The apparatus of clause 53, wherein the commodity function preference information is determined by:
determining the commodity function preference information according to historical interaction behavior information of the second users.
55. The apparatus of clause 54, wherein
the historical interaction behavior information comprises commodity object evaluation behavior information.
56. The apparatus of clause 53, wherein determining the first matching degree in the commodity function dimension according to the commodity function preference information of the second users for a commodity category to which one commodity object belongs and the commodity function information of the commodity object comprises:
determining the quantity of second users whose commodity function preference information matches the commodity function information; and
using a ratio of the quantity of the second users to the quantity of all second users as the first matching degree in the commodity function dimension.
57. The apparatus of clause 44, wherein the one or more processors configured to execute the set of instructions to cause the apparatus to further perform:
determining third feature information of the first user and fourth feature information of one or more third users corresponding to the commodity objects; and
determining one or more second matching degrees in at least one second feature dimension between the first user and the one or more third users according to the third feature information and the fourth feature information;
wherein determining the target commodity object information corresponding to the first user according to the one or more first matching degrees comprises:
determining the target commodity object information according to the one or more first matching degrees and the one or more second matching degrees.
58. The apparatus of clause 57, wherein
the third feature information comprises geographic location information;
the fourth feature information comprises geographic location information;
the at least one second feature dimension comprises a distance dimension; and
one second matching degree in the distance dimension among the one or more second matching degrees is determined according to the geographic location information of the first user and the geographic location information of one third user.
59. The apparatus of clause 57, wherein the one or more processors configured to execute the set of instructions to cause the apparatus to further perform:
determining quality information of the commodity objects and quality information of the third users; and
determining the target commodity object information at least according to the first matching degrees and the second matching degrees comprises:
determining the target commodity object information according to the first matching degrees, the second matching degrees, the quality information of the commodity objects, and the quality information of the third users.
60. The apparatus of clause 59, wherein
the quality information of one commodity object comprises a number of positive evaluations for the commodity.
61. The apparatus of clause 59, wherein
the quality information of one third user comprises the number of user's positive evaluations, logistics service quality information, customer service quality information, and a transaction dispute rate.
62. The apparatus of clause 61, wherein
the logistics service quality information comprises an average goods delivery time length; and
the customer service quality information comprises an average service response time length.
63. The apparatus of clause 59, wherein determining the target commodity object information according to the first matching degrees, the second matching degrees, the quality information of the commodity objects, and the quality information of the third users comprises:
determining third matching degrees between the first user and the commodity objects according to the first matching degrees in the at least one first feature dimension, the second matching degrees in the at least one second feature dimension, the quality information of the commodity objects, and the quality information of the third users; and
determining the target commodity object information according to the third matching degrees.
64. The apparatus of clause 63, wherein the third matching degrees are determined by:
according to weights of commodity selection parameters, using weighted values of the first matching degrees in the at least one first feature dimension, the second matching degrees in the at least one second feature dimension, the quality information of the commodity objects, and the quality information of the third users, as the third matching degrees.
65. The apparatus of clause 44, wherein the one or more processors configured to execute the set of instructions to cause the apparatus to further perform:
determining manual commodity selection parameter information of a target commodity object; and
sending the manual commodity selection parameter information to a client terminal of the first user for manual commodity selection by the first user according to the manual commodity selection parameter information.
66. The apparatus of clause 65, wherein the manual commodity selection parameter information comprises:
the first matching degree, commodity sales forecast information, commodity object information, and third user information.
67. The apparatus of clause 66, wherein
the commodity object information comprises: commodity static attribute information, the number of positive evaluations for the commodity, and transaction statistical data.
68. The apparatus of clause 66, wherein
the third user information comprises: user static attribute information, the number of user's positive evaluations, transaction statistical data, logistics service quality information, and customer service quality information.
69. The apparatus of any one of clause 67 or 68, wherein
the transaction statistical data comprises: the quantity of commodity transactions within a target time range, the quantity of orders, the amount of commodity transactions, and the quantity of return orders.
70. The apparatus of clause 66, wherein
the commodity sales forecast information comprises: commodity sales volume forecast information, commodity sales amount forecast information, and first user income forecast information.
71. The apparatus of clause 66, wherein the commodity sales forecast information is determined by:
determining at least one target second user according to the first matching degrees;
determining the sales volume forecast information according to a historical purchase quantity of each target second user for commodity objects in a commodity category to which the commodity object belongs;
determining the sales amount forecast information according to the sales volume forecast information; and
determining the first user income forecast information according to the sales amount forecast information.
72. An apparatus comprising:
a memory storing a set of instructions; and
one or more processors configured to execute the set of instructions to cause the apparatus to perform:
receiving target commodity object information for a target first user from a server; and
displaying the target commodity object information for manual commodity selection.
73. The apparatus of clause 72, wherein
the target commodity object information comprises manual commodity selection parameter information; and
the manual commodity selection parameter information comprises:
first matching degrees in at least one first feature dimension between a second user group corresponding to the target first user and the target commodity object, a second matching degree in at least one second feature dimension between the target first user and a third user of the target commodity object, sales forecast information of the target commodity object, commodity object information, and third user information.
74. An apparatus comprising:
a memory storing a set of instructions; and
one or more processors configured to execute the set of instructions to cause the apparatus to perform:
determining first feature information of at least one second user corresponding to first users and second feature information of a commodity object for sale of a third user;
determining first matching degrees in at least one first feature dimension between a second user group and the commodity object for sale according to the first feature information and the second feature information; and
determining target first user information corresponding to the third user at least according to the first matching degrees.
75. An apparatus comprising:
a memory storing a set of instructions; and
one or more processors configured to execute the set of instructions to cause the apparatus to perform:
receiving target first user information for a target third user from a server terminal; and
displaying the target first user information for manual host selection by the third user.
76. An apparatus comprising:
a memory storing a set of instructions; and
one or more processors configured to execute the set of instructions to cause the apparatus to perform:
acquiring historical interaction behavior information of a second user; and
determining commodity transaction preference information of the second user according to the historical interaction behavior information.
77. The apparatus of clause 76, wherein
the historical interaction behavior information comprises: commodity object purchase behavior information, commodity object browsing behavior information, commodity object favoriting behavior information, and commodity object evaluation behavior information.
78. The apparatus of clause 76, wherein
the commodity transaction preference information comprises: commodity category preference information, commodity price preference information for different commodity categories, and commodity function preference information for different commodity categories.
79. An apparatus comprising:
a memory storing a set of instructions; and
one or more processors configured to execute the set of instructions to cause the apparatus to perform:
acquiring historical live sales behavior information of a first user; and
determining commodity sales preference information of the first user according to the behavior information.
80. The apparatus of clause 79, wherein
the commodity sales preference information comprises commodity category preference information.
81. An apparatus comprising:
a memory storing a set of instructions; and
one or more processors configured to execute the set of instructions to cause the apparatus to perform:
determining first feature information of at least one second user corresponding to a first user and second feature information of to-be-selected commodity objects;
determining a first degree of difference in at least one first feature dimension between a second user group and the to-be-selected commodity objects according to the first feature information and the second feature information;
filtering out, at least according to the first degree of difference, a commodity object among the to-be-selected commodity objects that does not correspond to the first user; and
using the to-be-selected commodity object after the filtering-out as a target commodity object corresponding to the first user.
82. An apparatus comprising:
a memory storing a set of instructions; and
one or more processors configured to execute the set of instructions to cause the apparatus to perform:
determining commodity sales exclusion information of a first user and feature information of to-be-selected commodity objects;
determining a first degree of difference between the first user and the to-be-selected commodity objects according to the exclusion information and the feature information;
filtering out, at least according to the first degree of difference, a commodity object among the to-be-selected commodity objects that does not correspond to the first user; and
using the to-be-selected commodity object after the filtering-out as a target commodity object corresponding to the first user.
83. The apparatus of clause 82, wherein
the commodity sales exclusion information comprises: commodity category exclusion information, commodity price exclusion information, commodity function exclusion information, and merchant geographical region exclusion information; and
the feature information comprises: commodity category information, commodity price information, commodity function information, and merchant geographical region information.
84. An apparatus comprising:
a memory storing a set of instructions; and
one or more processors configured to execute the set of instructions to cause the apparatus to perform:
determining a plurality pieces of first user information located in a target place;
determining first feature information of at least one second user corresponding to the first users and second feature information of a commodity object for sale of a third user in the target place;
determining first matching degrees in at least one first feature dimension between a second user group and the commodity object for sale according to the first feature information and the second feature information; and
determining target first user information corresponding to the third user among the plurality of pieces of first user information according to the first matching degrees.
85. The apparatus of clause 84, wherein
the target place comprises a shopping place, a tourist place, and a restaurant.
86. An apparatus comprising:
a memory storing a set of instructions; and
one or more processors configured to execute the set of instructions to cause the apparatus to perform:
receiving target first user information for a third user in a target place from a server; and
displaying the target first user information for the third user to determine a host for live broadcast sales of commodity objects.
87. A non-transitory computer readable medium that stores a set of instructions that is executable by at least one processor of a computer to cause the computer to perform a data processing method, the method comprising:
determining first feature information of one or more second users corresponding to a first user and second feature information of one or more to-be-selected commodity objects;
determining one or more first matching degrees in at least one first feature dimension between the one or more second users and the one or more to-be-selected commodity objects according to the first feature information and the second feature information; and
determining target commodity object information corresponding to the first user according to the one or more first matching degrees.
88. The non-transitory computer readable medium of clause 87, wherein:
the first feature information comprises commodity category preference information;
the second feature information comprises commodity category information;
the at least one first feature dimension comprises a commodity category dimension; and
one first matching degree in the commodity category dimension among the one or more first matching degrees is determined by the following:
determining third matching degrees between the one or more second users and a commodity category of one to-be-selected commodity object according to the commodity category preference information; and
determining the first matching degree in the commodity category dimension according to the third matching degrees.
89. The non-transitory computer readable medium of clause 87, wherein the commodity category preference information is determined according to historical interaction behavior information of the second user.
90. The non-transitory computer readable medium of clause 89, wherein
the historical interaction behavior information comprises: commodity object purchase behavior information, commodity object browsing behavior information, commodity object favoriting behavior information, and commodity object evaluation behavior information.
91. The non-transitory computer readable medium of clause 88, wherein determining the first matching degree in the commodity category dimension according to the third matching degrees comprises:
using an average value of the third matching degrees as the first matching degree in the commodity category dimension.
92. The non-transitory computer readable medium of clause 88, wherein determining the first matching degree in the commodity category dimension according to the third matching degrees comprises:
determining the quantity of second users whose third matching degrees are greater than a third matching degree threshold; and
using a ratio of the quantity of the second users to the quantity of all second users as the first matching degree in the commodity category dimension.
93. The non-transitory computer readable medium of clause 87, wherein:
the first feature information comprises commodity price preference information for a plurality of commodity categories;
the second feature information comprises commodity price information;
the at least one first feature dimension comprises commodity price dimension; and
one first matching degree in the commodity price dimension among the one or more first matching degrees is determined according to the commodity price preference information of the one or more second users for a commodity category to which one commodity object belongs and the commodity price information of the one commodity object.
94. The non-transitory computer readable medium of clause 93, wherein the commodity price preference information is determined by:
determining the commodity price preference information according to historical interaction behavior information of the second users.
95. The non-transitory computer readable medium of clause 93, wherein determining the first matching degree in the price dimension according to the commodity price preference information of the second users for a commodity category to which one commodity object belongs and the commodity price information of the commodity object comprises:
determining the quantity of second users whose commodity price preference information matches the commodity price information; and
using a ratio of the quantity of the second users to the quantity of all second users as the first matching degree in the commodity price dimension.
96. The non-transitory computer readable medium of clause 87, wherein:
the first feature information comprises commodity function preference information for a plurality of commodity categories;
the second feature information comprises commodity function information;
the at least one first feature dimension comprises commodity function dimension; and
one first matching degree in the commodity function dimension among the one or more first matching degrees is determined according to the commodity function preference information of the one or more second users for a commodity category to which one commodity object belongs and the commodity function information of the one commodity object.
97. The non-transitory computer readable medium of clause 96, wherein the commodity function preference information is determined by:
determining the commodity function preference information according to historical interaction behavior information of the second users.
98. The non-transitory computer readable medium of clause 97, wherein
the historical interaction behavior information comprises commodity object evaluation behavior information.
99. The non-transitory computer readable medium of clause 96, wherein determining the first matching degree in the commodity function dimension according to the commodity function preference information of the second users for a commodity category to which one commodity object belongs and the commodity function information of the commodity object comprises:
determining the quantity of second users whose commodity function preference information matches the commodity function information; and
using a ratio of the quantity of the second users to the quantity of all second users as the first matching degree in the commodity function dimension.
100. The non-transitory computer readable medium of clause 87, wherein the at least one processor configured to execute the set of instructions to cause the computer to further perform:
determining third feature information of the first user and fourth feature information of one or more third users corresponding to the commodity objects; and
determining one or more second matching degrees in at least one second feature dimension between the first user and the one or more third users according to the third feature information and the fourth feature information;
wherein determining the target commodity object information corresponding to the first user according to the one or more first matching degrees comprises:
determining the target commodity object information according to the one or more first matching degrees and the one or more second matching degrees.
101. The non-transitory computer readable medium of clause 100, wherein:
the third feature information comprises geographic location information;
the fourth feature information comprises geographic location information;
the at least one second feature dimension comprises a distance dimension; and
one second matching degree in the distance dimension among the one or more second matching degrees is determined according to the geographic location information of the first user and the geographic location information of one third user.
102. The non-transitory computer readable medium of clause 100, wherein the at least one processor configured to execute the set of instructions to cause the computer to further perform:
determining quality information of the commodity objects and quality information of the third users; and
determining the target commodity object information at least according to the first matching degrees and the second matching degrees comprises:
determining the target commodity object information according to the first matching degrees, the second matching degrees, the quality information of the commodity objects, and the quality information of the third users.
103. The non-transitory computer readable medium of clause 102, wherein
the quality information of one commodity object comprises a number of positive evaluations for the commodity.
104. The non-transitory computer readable medium of clause 102, wherein
the quality information of one third user comprises the number of user's positive evaluations, logistics service quality information, customer service quality information, and a transaction dispute rate.
105. The non-transitory computer readable medium of clause 104, wherein
the logistics service quality information comprises an average goods delivery time length; and
the customer service quality information comprises an average service response time length.
106. The non-transitory computer readable medium of clause 102, wherein determining the target commodity object information according to the first matching degrees, the second matching degrees, the quality information of the commodity objects, and the quality information of the third users comprises:
determining third matching degrees between the first user and the commodity objects according to the first matching degrees in the at least one first feature dimension, the second matching degrees in the at least one second feature dimension, the quality information of the commodity objects, and the quality information of the third users; and
determining the target commodity object information according to the third matching degrees.
107. The non-transitory computer readable medium of clause 106, wherein the third matching degrees are determined by:
according to weights of commodity selection parameters, using weighted values of the first matching degrees in the at least one first feature dimension, the second matching degrees in the at least one second feature dimension, the quality information of the commodity objects, and the quality information of the third users, as the third matching degrees.
108. The non-transitory computer readable medium of clause 87, wherein the at least one processor configured to execute the set of instructions to cause the computer to further perform:
determining manual commodity selection parameter information of a target commodity object; and
sending the manual commodity selection parameter information to a client terminal of the first user for manual commodity selection by the first user according to the manual commodity selection parameter information.
109. The non-transitory computer readable medium of clause 108, wherein the manual commodity selection parameter information comprises:
the first matching degree, commodity sales forecast information, commodity object information, and third user information.
110. The non-transitory computer readable medium of clause 109, wherein
the commodity object information comprises: commodity static attribute information, the number of positive evaluations for the commodity, and transaction statistical data.
111. The non-transitory computer readable medium of clause 109, wherein
the third user information comprises: user static attribute information, the number of user's positive evaluations, transaction statistical data, logistics service quality information, and customer service quality information.
112. The non-transitory computer readable medium of any one of clause 110 or 111, wherein
the transaction statistical data comprises: the quantity of commodity transactions within a target time range, the quantity of orders, the amount of commodity transactions, and the quantity of return orders.
113. The non-transitory computer readable medium of clause 109, wherein
the commodity sales forecast information comprises: commodity sales volume forecast information, commodity sales amount forecast information, and first user income forecast information.
114. The non-transitory computer readable medium of clause 109, wherein the commodity sales forecast information is determined by:
determining at least one target second user according to the first matching degrees;
determining the sales volume forecast information according to a historical purchase quantity of each target second user for commodity objects in a commodity category to which the commodity object belongs;
determining the sales amount forecast information according to the sales volume forecast information; and
determining the first user income forecast information according to the sales amount forecast information.
115. A non-transitory computer readable medium that stores a set of instructions that is executable by at least one processor of a computer to cause the computer to perform a method, the method comprising:
receiving target commodity object information for a target first user from a server; and
displaying the target commodity object information for manual commodity selection.
116. The non-transitory computer readable medium of clause 115, wherein
the target commodity object information comprises manual commodity selection parameter information; and
the manual commodity selection parameter information comprises:
first matching degrees in at least one first feature dimension between a second user group corresponding to the target first user and the target commodity object, a second matching degree in at least one second feature dimension between the target first user and a third user of the target commodity object, sales forecast information of the target commodity object, commodity object information, and third user information.
117. A non-transitory computer readable medium that stores a set of instructions that is executable by at least one processor of a computer to cause the computer to perform a method, the method comprising:
determining first feature information of at least one second user corresponding to first users and second feature information of a commodity object for sale of a third user;
determining first matching degrees in at least one first feature dimension between a second user group and the commodity object for sale according to the first feature information and the second feature information; and
determining target first user information corresponding to the third user at least according to the first matching degrees.
118. A non-transitory computer readable medium that stores a set of instructions that is executable by at least one processor of a computer to cause the computer to perform a method, the method comprising:
receiving target first user information for a target third user from a server terminal; and
displaying the target first user information for manual host selection by the third user.
119. A non-transitory computer readable medium that stores a set of instructions that is executable by at least one processor of a computer to cause the computer to perform a method, the method comprising:
acquiring historical interaction behavior information of a second user; and
determining commodity transaction preference information of the second user according to the historical interaction behavior information.
120. The non-transitory computer readable medium of clause 119, wherein
the historical interaction behavior information comprises: commodity object purchase behavior information, commodity object browsing behavior information, commodity object favoriting behavior information, and commodity object evaluation behavior information.
121. The non-transitory computer readable medium of clause 119, wherein
the commodity transaction preference information comprises: commodity category preference information, commodity price preference information for different commodity categories, and commodity function preference information for different commodity categories.
122. A non-transitory computer readable medium that stores a set of instructions that is executable by at least one processor of a computer to cause the computer to perform a method, the method comprising:
acquiring historical live sales behavior information of a first user; and
determining commodity sales preference information of the first user according to the behavior information.
123. The non-transitory computer readable medium of clause 122, wherein
the commodity sales preference information comprises commodity category preference information.
124. A non-transitory computer readable medium that stores a set of instructions that is executable by at least one processor of a computer to cause the computer to perform a method, the method comprising:
determining first feature information of at least one second user corresponding to a first user and second feature information of to-be-selected commodity objects;
determining a first degree of difference in at least one first feature dimension between a second user group and the to-be-selected commodity objects according to the first feature information and the second feature information;
filtering out, at least according to the first degree of difference, a commodity object among the to-be-selected commodity objects that does not correspond to the first user; and
using the to-be-selected commodity object after the filtering-out as a target commodity object corresponding to the first user.
125. A non-transitory computer readable medium that stores a set of instructions that is executable by at least one processor of a computer to cause the computer to perform a method, the method comprising:
determining commodity sales exclusion information of a first user and feature information of to-be-selected commodity objects;
determining a first degree of difference between the first user and the to-be-selected commodity objects according to the exclusion information and the feature information;
filtering out, at least according to the first degree of difference, a commodity object among the to-be-selected commodity objects that does not correspond to the first user; and
using the to-be-selected commodity object after the filtering-out as a target commodity object corresponding to the first user.
126. The non-transitory computer readable medium of clause 125, wherein
the commodity sales exclusion information comprises: commodity category exclusion information, commodity price exclusion information, commodity function exclusion information, and merchant geographical region exclusion information; and
the feature information comprises: commodity category information, commodity price information, commodity function information, and merchant geographical region information.
127. A non-transitory computer readable medium that stores a set of instructions that is executable by at least one processor of a computer to cause the computer to perform a method, the method comprising:
determining a plurality pieces of first user information located in a target place;
determining first feature information of at least one second user corresponding to the first users and second feature information of a commodity object for sale of a third user in the target place;
determining first matching degrees in at least one first feature dimension between a second user group and the commodity object for sale according to the first feature information and the second feature information; and
determining target first user information corresponding to the third user among the plurality of pieces of first user information according to the first matching degrees.
128. The non-transitory computer readable medium of clause 127, wherein
the target place comprises a shopping place, a tourist place, and a restaurant.
129. A non-transitory computer readable medium that stores a set of instructions that is executable by at least one processor of a computer to cause the computer to perform a method, the method comprising:
receiving target first user information for a third user in a target place from a server; and
displaying the target first user information for the third user to determine a host for live broadcast sales of commodity objects.

Based on the several embodiments provided in the present disclosure, it should be appreciated that the disclosed technical contents may be implemented in another manner. The described apparatus, system, and method embodiments are only exemplary. For example, division of units or modules are merely exemplary division based on the logical functions. Division in another manner may exist in actual implementation. Further, a plurality of units or components may be combined or integrated into another system. Some features or components may be omitted or modified in some embodiments. In addition, the mutual coupling or direct coupling or communication connections displayed or discussed may be implemented by using some interfaces. The indirect coupling or communication connections between the units or modules may be implemented electrically or in another form.

Further, the units described as separate parts may or may not be physically separate. Parts displayed as units may or may not be physical units. They may be located in a same location or may be distributed on a plurality of network units. Some or all of the units may be selected according to actual needs to achieve the objectives of the solutions of the embodiments. In addition, functional units in the embodiments of the present disclosure may be integrated into one processing unit. Each of the units may exist alone physically, or two or more units can be integrated into one unit. The integrated unit may be implemented in a form of hardware or may be implemented in a form of a software functional unit.

It is appreciated that the above described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

It is appreciated that the above descriptions are only exemplary embodiments provided in the present disclosure. Consistent with the present disclosure, those of ordinary skill in the art may incorporate variations and modifications in actual implementation, without departing from the principles of the present disclosure. Such variations and modifications shall all fall within the protection scope of the present disclosure.

It is appreciated that all or some of the procedures in the methods of the foregoing embodiments can be implemented by a program instructing relevant hardware components of a terminal device. The program can be stored in a computer readable storage medium. The storage medium comprises a flash memory, a Read-Only Memory (ROM), a Random Access Memory (RAM), a magnetic disk, or an optical disc.

In some embodiments, a non-transitory computer-readable storage medium including instructions is also provided, and the instructions may be executed by a device, for performing the above-described methods. Common forms of non-transitory media comprise, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may comprise one or more processors (CPUs), an input/output interface, a network interface, or a memory.

It is appreciated that all or some of the procedures in the methods of the foregoing embodiments can be implemented by a program instructing relevant hardware components of a terminal device. The program can be stored in a computer readable storage medium. The storage medium comprises a flash memory, a Read-Only Memory (ROM), a Random Access Memory (RAM), a magnetic disk, or an optical disc.

What is claimed is:

1. A data processing method, comprising:
determining first feature information of one or more second users corresponding to a first user and second feature information of one or more to-be-selected commodity objects;
determining one or more first matching degrees in at least one first feature dimension between the one or more second users and the one or more to-be-selected commodity objects according to the first feature information and the second feature information; and
determining target commodity object information corresponding to the first user according to the one or more first matching degrees.

2. The method according to claim 1, wherein
the first feature information comprises commodity category preference information;
the second feature information comprises commodity category information;
the at least one first feature dimension comprises a commodity category dimension; and
at least one first matching degree in the commodity category dimension among the one or more first matching degrees is determined by the following:
determining third matching degrees between the one or more second users and a commodity category of one to-be-selected commodity object according to the commodity category preference information; and
determining the first matching degree in the commodity category dimension according to the third matching degrees.

3. The method according to claim 2, wherein the commodity category preference information is determined according to historical interaction behavior information of the second user.

4. The method according to claim 1, wherein
the first feature information comprises commodity price preference information for a plurality of commodity categories;
the second feature information comprises commodity price information;
the at least one first feature dimension comprises commodity price dimension; and
at least one first matching degree in the commodity price dimension among the one or more first matching degrees is determined according to the commodity price preference information of the one or more second users for a commodity category to which one commodity object belongs and the commodity price information of the one commodity object.

5. The method according to claim 1, wherein
the first feature information comprises commodity function preference information for a plurality of commodity categories;
the second feature information comprises commodity function information;
the at least one first feature dimension comprises commodity function dimension; and
at least one first matching degree in the commodity function dimension among the one or more first matching degrees is determined according to the commodity function preference information of the one or more second users for a commodity category to which one commodity object belongs and the commodity function information of the one commodity object.

6. The method according to claim 1, further comprising:
determining third feature information of the first user and fourth feature information of one or more third users corresponding to the commodity objects; and
determining one or more second matching degrees in at least one second feature dimension between the first user and the one or more third users according to the third feature information and the fourth feature information;
wherein determining the target commodity object information corresponding to the first user according to the one or more first matching degrees comprises:
determining the target commodity object information according to the one or more first matching degrees and the one or more second matching degrees.

7. The method according to claim 6, wherein
the third feature information comprises geographic location information;
the fourth feature information comprises geographic location information;
the at least one second feature dimension comprises a distance dimension; and
at least one second matching degree in the distance dimension among the one or more second matching degrees is determined according to the geographic location information of the first user and the geographic location information of one third user.

8. A data processing apparatus, comprising:
a memory storing a set of instructions; and
one or more processors configured to execute the set of instructions to cause the apparatus to perform:
determining first feature information of one or more second users corresponding to a first user and second feature information of one or more to-be-selected commodity objects;
determining one or more first matching degrees in at least one first feature dimension between the one or more second users and the one or more to-be-selected commodity objects according to the first feature information and the second feature information; and
determining target commodity object information corresponding to the first user according to the one or more first matching degrees.

9. The apparatus of claim 8, wherein the one or more processors is configured to execute the set of instructions to cause the apparatus to further perform:
the first feature information comprises commodity category preference information;
the second feature information comprises commodity category information;
the at least one first feature dimension comprises a commodity category dimension; and
at least one first matching degree in the commodity category dimension among the one or more first matching degrees is determined by the following:
determining third matching degrees between the one or more second users and a commodity category of one to-be-selected commodity object according to the commodity category preference information; and
determining the first matching degree in the commodity category dimension according to the third matching degrees.

10. The apparatus of claim 9, wherein the commodity category preference information is determined according to historical interaction behavior information of the second user.

11. The apparatus of claim 8, wherein
the first feature information comprises commodity price preference information for a plurality of commodity categories;
the second feature information comprises commodity price information;
the at least one first feature dimension comprises commodity price dimension; and
at least one first matching degree in the commodity price dimension among the one or more first matching degrees is determined according to the commodity price preference information of the one or more second users for a commodity category to which one commodity object belongs and the commodity price information of the one commodity object.

12. The apparatus of claim 8, wherein
the first feature information comprises commodity function preference information for a plurality of commodity categories;
the second feature information comprises commodity function information;
the at least one first feature dimension comprises commodity function dimension; and
at least one first matching degree in the commodity function dimension among the one or more first matching degrees is determined according to the commodity function preference information of the one or more second users for a commodity category to which one commodity object belongs and the commodity function information of the one commodity object.

13. The apparatus of claim 8, wherein the one or more processors is configured to execute the set of instructions to cause the apparatus to further perform:
determining third feature information of the first user and fourth feature information of one or more third users corresponding to the commodity objects; and
determining one or more second matching degrees in at least one second feature dimension between the first user and the one or more third users according to the third feature information and the fourth feature information;
wherein determining the target commodity object information corresponding to the first user according to the one or more first matching degrees comprises:
determining the target commodity object information according to the one or more first matching degrees and the one or more second matching degrees.

14. A non-transitory computer readable medium that stores a set of instructions that is executable by at least one processor of a computer to cause the computer to perform a data processing method, the method comprising:
determining first feature information of one or more second users corresponding to a first user and second feature information of one or more to-be-selected commodity objects;
determining one or more first matching degrees in at least one first feature dimension between the one or more second users and the one or more to-be-selected commodity objects according to the first feature information and the second feature information; and
determining target commodity object information corresponding to the first user according to the one or more first matching degrees.

15. The non-transitory computer readable medium of claim 14, wherein:
the first feature information comprises commodity category preference information;
the second feature information comprises commodity category information;
the at least one first feature dimension comprises a commodity category dimension; and
at least one first matching degree in the commodity category dimension among the one or more first matching degrees is determined by the following:
determining third matching degrees between the one or more second users and a commodity category of one to-be-selected commodity object according to the commodity category preference information; and
determining the first matching degree in the commodity category dimension according to the third matching degrees.

16. The non-transitory computer readable medium of claim 15, wherein the commodity category preference information is determined according to historical interaction behavior information of the second user.

17. The non-transitory computer readable medium of claim 14, wherein:
the first feature information comprises commodity price preference information for a plurality of commodity categories;
the second feature information comprises commodity price information;
the at least one first feature dimension comprises commodity price dimension; and
at least one first matching degree in the commodity price dimension among the one or more first matching degrees is determined according to the commodity price preference information of the one or more second users for a commodity category to which one commodity object belongs and the commodity price information of the one commodity object.

18. The non-transitory computer readable medium of claim 14, wherein:
the first feature information comprises commodity function preference information for a plurality of commodity categories;
the second feature information comprises commodity function information;
the at least one first feature dimension comprises commodity function dimension; and
at least one first matching degree in the commodity function dimension among the one or more first matching degrees is determined according to the commodity function preference information of the one or more second users for a commodity category to which one commodity object belongs and the commodity function information of the one commodity object.

19. The non-transitory computer readable medium of claim 14, wherein the at least one processor is configured to execute the set of instructions to cause the computer to further perform:
determining third feature information of the first user and fourth feature information of one or more third users corresponding to the commodity objects; and
determining one or more second matching degrees in at least one second feature dimension between the first user and the one or more third users according to the third feature information and the fourth feature information;
wherein determining the target commodity object information corresponding to the first user according to the one or more first matching degrees comprises:
determining the target commodity object information according to the one or more first matching degrees and the one or more second matching degrees.

20. The non-transitory computer readable medium of claim 19, wherein:
the third feature information comprises geographic location information;
the fourth feature information comprises geographic location information;
the at least one second feature dimension comprises a distance dimension; and
at least one second matching degree in the distance dimension among the one or more second matching degrees is determined according to the geographic location information of the first user and the geographic location information of one third user.
